(19) United States
(12) Patent Application Publication
(10) Pub. No.: US 2020/0249590 A1
(43) Pub. Date: Aug. 6, 2020

(54) ELECTROPHOTOGRAPHIC PHOTOSENSITIVE MEMBER, ELECTROPHOTOGRAPHIC APPARATUS, AND PROCESS CARTRIDGE

(71) Applicant: CANON KABUSHIKI KAISHA, Tokyo (JP)

(72) Inventors: Koichi Nakata, Tokyo (JP); Haruki Mori, Nagareyama-shi (JP); Shubun Kujirai, Toride-shi (JP)

(21) Appl. No.: 16/777,173

(22) Filed: Jan. 30, 2020

(30) Foreign Application Priority Data
Feb. 5, 2019 (JP) 2019-018940

(51) Int. Cl. G03G 5/06; G03G 5/05; G03G 5/047; G03G 21/18

(52) U.S. Cl. CPC G03G 5/0614; G03G 21/1814; G03G 5/047; G03G 5/0592

(57) ABSTRACT

An electrophotographic photosensitive member which satisfies wear resistance and electrical properties, further has high image deletion prevention properties under a high temperature and high humidity environment, and a small potential variation under a low temperature and low humidity environment is provided. The electrophotographic photosensitive member includes a surface layer containing a polymerization product of a hole transporting compound having a specific structure.

### BACKGROUND OF THE INVENTION

### Field of the Invention

The present disclosure relates to an electrophotographic photosensitive member, and an electrophotographic apparatus and a process cartridge which include the electrophotographic photosensitive member.

### Description of the Related Art

A surface layer of an electrophotographic photosensitive member repeatedly undergoes stresses from a series of electrophotographic processes such as charge, exposure to light, developing, transfer, and cleaning, and thus should have wear resistance and chemical stability.

Examples of methods for improving wear resistance include a method of containing a curable resin in the surface layer of an electrophotographic photosensitive member. Unfortunately, if a surface layer having high wear resistance is disposed, the surface layer barely wears. As a result, the surface of the surface layer is barely refreshed, facilitating accumulation of chemical degradation on the surface. Here, the term “chemical degradation” indicates a phenomenon that a hole transporting compound and other substances (hereinafter, also referred to as “hole transporting compound and the like”) forming the surface layer undergo chemical changes due to stresses by the series of electrophotographic processes.

The chemical changes of the hole transporting compound and the like may cause a phenomenon (hereinafter, also referred to as “image deletion”) that unclear electrophotographic images are output particularly under a high temperature and high humidity environment in some cases. Accordingly, the chemical changes of the hole transporting compound and the like should be prevented to prevent image deletion.

Examples of methods of improving the chemical stability of the hole transporting compound and the like include a technique of containing additives with a hole transporting compound in a surface layer. Japanese Patent Application Laid-Open No. 2007-11005 discloses a technique of improving image deletion by adding a specific fluorine atom-containing monomer having a polymerizable functional group to the surface layer. Japanese Patent Application Laid-Open No. 2007-272191, Japanese Patent Application Laid-Open No. 2007-272192, and Japanese Patent Application Laid-Open No. 2007-279678 disclose techniques of improving image deletion by adding a specific amine compound to a surface layer.

Japanese Patent Application Laid-Open No. 2008-70761 discloses a technique of improving image deletion by adding a specific siloxane compound having a specific polymerizable functional group to a surface layer. Japanese Patent Application Laid-Open No. 2009-237115 discloses a hole transporting compound having a variety of polymerizable functional groups.

The techniques according to these Japanese Patent Applications above are techniques for reducing exposure to the stresses applied to the hole transporting compound and the like, and any technique of improving the chemical stability of the hole transporting compound and the like themselves is not disclosed therein.

Recently, with an increase in durability of the electrophotographic photosensitive member, the photosensitive member after long-term use should not cause image deletion. To improve image deletion, not only reduction of the exposure to the stresses but also an improvement in the chemical stability of the hole transporting compound itself are required. In addition, prevention of a change in electrical properties in long-term use of a highly durable photosensitive member under a specific low temperature and low humidity environment is required.

### SUMMARY OF THE INVENTION

One aspect of the present disclosure is directed to providing an electrophotographic photosensitive member which has high durability, satisfies electrical properties, has an excellent effect to prevent image deletion under a high temperature and high humidity environment, and a small potential variation under a low temperature and low humidity environment.

Another aspect of the present disclosure is directed to providing an electrophotographic apparatus and a process cartridge including the electrophotographic photosensitive member.

Furthermore, another aspect of the present disclosure is directed to providing a method of manufacturing an electrophotographic photosensitive member which has high durability, satisfies electrical properties, has an excellent effect to prevent image deletion under a high temperature and high humidity environment, and has a small potential variation under a low temperature and low humidity environment.

According to one aspect of the present disclosure, there is provided an electrophotographic photosensitive member include a support and a photosensitive layer on the support, a surface layer of the electrophotographic photosensitive member containing a copolymerization product of a composition including a hole transporting compound represented by Formula (1) and a compound represented by Formula (2).

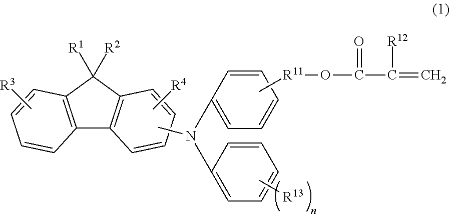

(where R¹ and R² each independently represent an alkyl group having 1 or more and 8 or less carbon atoms; R³ and R⁴ each independently represent a hydrogen atom or an alkyl group having 1 or more and 4 or less carbon atoms; R¹¹ represents an alkylene group having 2 or more and 6 or less carbon atom; Rⁿ represents a hydrogen atom, an alkyl group having 1 or more and 4 or less carbon atoms, an alkoxy group having 4 or less carbon atoms, a phenyl group, or a benzyl group; n represents 1 to 5; R¹² represents a hydrogen atom or a methyl group);

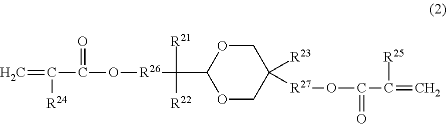

(where R²¹ and R²² each independently represent an alkyl group having 1 or more and 4 or less carbon atoms or a substituted or unsubstituted aryl group; the substituent included in the aryl group is an alkyl group having 1 or more and 4 or less carbon atoms; R²¹ and R²² may be bonded to each other to form a ring; R²³ represents an alkyl group having 1 or more and 4 or less carbon atoms; R²⁴ and R²⁵ each independently represent a hydrogen atom or a methyl group; R²⁶ and R²⁷ each independently represent an alkylene group having 1 or more and 4 or less carbon atoms).

According to another aspect of the present disclosure, there is provided an electrophotographic apparatus including the electrophotographic photosensitive member, a charging unit, an exposure unit, a developing unit, and a transfer unit.

According to another aspect of the present disclosure, there is provided a process cartridge which integrally support the electrophotographic photosensitive member and at least one unit selected from the group consisting of a charging unit, a developing unit, a transfer unit, and a cleaning unit, and is detachable from the main body of an electrophotographic apparatus.

Furthermore, according to another aspect of the present disclosure, there is provided a method of manufacturing an electrophotographic photosensitive member including a support and a photosensitive layer on the support, the method including forming a coating of a coating solution for a surface layer containing a hole transporting compound represented by Formula (1) and a compound represented by Formula (2), and curing the coating to form a surface layer of the electrophotographic photosensitive member.

Further features of the present invention will become apparent from the following description of exemplary embodiments with reference to the attached drawings.

### BRIEF DESCRIPTION OF THE DRAWINGS

FIG. 1 is a schematic view illustrating one example of a process cartridge including an electrophotographic photosensitive member.

FIG. 2 is a schematic view illustrating one example of an electrophotographic apparatus including an electrophotographic photosensitive member.

FIG. 3 is a schematic view illustrating one example of an apparatus to process the surface of the electrophotographic photosensitive member by pressure welding shape transfer.

FIGS. 4A, 4B and 4C are schematic views illustrating one example of a stamper mold for press bonding.

### DESCRIPTION OF THE EMBODIMENTS

Preferred embodiments of the present disclosure will now be described in detail in accordance with the accompanying drawings.

The present disclosure relates to an electrophotographic photosensitive member including a surface layer containing a copolymerization product of a polymerizable hole transport compound having a specific amino fluorene structure. Hereinafter, the hole transporting compound having a polymerizable functional group and having these features is also referred to as a hole transporting compound according to the present disclosure.

In general, arylamine compounds having high hole transportability are widely used as the hole transporting compound used in the electrophotographic photosensitive member.

It is believed that the hole transportability of the arylamine compound is demonstrated by the amine structure having electron donating properties, which forms a molecular orbital with an aryl group or the like around the nitrogen atom to cause oxidation/reduction.

On the other hand, it is believed that the arylamine site is readily subjected to a chemical reaction or the like because charges are actively donated and received through the repeated electrophotographic process. In particular, it is believed that the arylamine site will readily undergo changes such as oxidation due to discharged energy in the charging step or the action of ozone and oxidative substances generated by a discharging phenomenon.

It is inferred that this results in the chemical changes of the arylamine site. In particular, it is believed that under a high temperature and high humidity environment, a combination of the chemical changes of the hole transporting compound with generation of discharge products and invasion of the moisture from the environment reduces the resistance of the surface of the photosensitive member, causing image defects such as the so-called image deletion.

The present inventors have searched for a hole transporting compound which allows prevention of degradation while having an amine structure, and can function with high stability and high durability, and have found the hole transporting compound according to the present disclosure.

In other words, the hole transporting compound according to the present disclosure has an alkyl group having the specific number of carbon atoms in a specific position in the molecule to prevent degradation of an aromatic amine hole transport compound. Specifically, the hole transporting compound having a fluorene structure has an alkyl group having the specific number of carbon atoms at a 9-position of the fluorene in the structure. It is believed that such a configuration can improve the hydrophobicity of the hole transporting compound and can effectively reduce the affinity with moisture. As a result, a reduction in resistance can be prevented.

It should be noted that a hole transporting compound having an alkyl group having a large number of carbon atoms may worsen the specific electrical properties. In particular, continuous use under a low temperature and low humidity environment may cause a phenomenon that the potential variation in the bright potential of the photosensitive member is increased.

These phenomena may cause a variation in color nuance of images in electrophotographic apparatuses which output color images in particular while images are continuously output from the print initial stage.

However, the electrophotographic photosensitive member including a surface layer containing a polymerization product of the fluorene polymerizable hole transporting compound according to the present disclosure can have a high level of compatibility between the prevention of image deletion under a high temperature and high humidity environment and the prevention of the potential variation during continuous use under a low temperature and low humidity environment.

It is believed that the reason is that the hole transporting compound according to the present disclosure can attain a high level of compatibility between the chemical stability and the electrical properties because the compound has an alkyl group having the specific number of carbon atoms in a site which barely imparts adverse effects to the hole transport function.

The hole transporting compound according to the present disclosure has a fluorene structure represented by Formula (1):

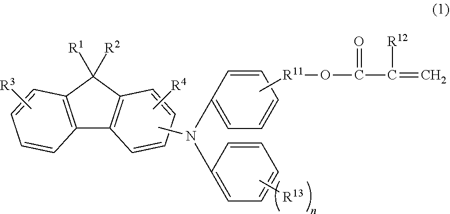

(where R¹ and R² each independently represent an alkyl group having 1 or more and 8 or less carbon atoms; R³ and R⁴ each independently represent a hydrogen atom or an alkyl group having 1 or more and 4 or less carbon atoms; R¹¹ represents an alkylene group having 2 or more and 6 or less carbon atom; R¹³ represents a hydrogen atom, an alkyl group having 1 or more and 4 or less carbon atoms, an alkoxy group having 1 or more and 4 or less carbon atoms, a phenyl group, or a benzyl group; n represents 1 to 5; R¹² represents a hydrogen atom or a methyl group).

The requirements essential to the hole transporting compound according to the present disclosure will now be described for each of the structures included in Formula (1). In the hole transporting compound according to the present disclosure, R¹ and R² bonded to the 9-position of the fluorene structure each independently are an alkyl group having 1 or more and 8 or less carbon atoms.

The fluorene structure is formed such that a 5-membered ring and 6-membered rings are condensed, and has high planarity. On the other hand, only the carbon atom located at the 9-position of the fluorene structure is the carbon atom forming an sp3 hybrid orbital. The carbon atom is located in a direction different from the plane formed by the three condensation rings. It is believed that such a positional relation results in a structure in which the hole transport properties are barely inhibited even with a large number of carbon atoms.

It is inferred that for such a reason above, the hole transportability is not inhibited even though an alkyl group having a large number of carbon atoms is present near an aromatic amino group of the hole transporting compound.

If an alkyl group having a large number of carbon atoms is present, the hydrophobicity of the hole transporting compound can be improved, and image deletion properties under a high temperature and high humidity environment can be improved.

In General Formula (1), if R¹ and R² bonded to the 9-position of the fluorene structure have the excessively large number of carbon atoms, the electrical properties may be inhibited. For this reason, the number of carbon atoms is 1 or more and 8 or less, preferably 1 or more and 6 or less carbon atoms. The number is more preferably 2 or more and 4 or less carbon atoms. Further, a propyl group is preferred.

It is believed that an alkyl group having an excessively long carbon chain may increase steric hindrance to an aromatic amino group or the like to increase the disorder between hole transporting compound molecules, inhibiting the hole transportability.

Examples of alkyl groups for R¹ and R² include a methyl group, an ethyl group, an n-propyl group, an isopropyl group, an n-butyl group, an isobutyl group, an sec-butyl group, a tert-butyl group, an n-pentyl group, an isopentyl group, a neopentyl group, a tert-pentyl group, a cyclopentyl group, an n-hexyl group, a 1-methylpentyl group, a 4-methyl-2-pentyl group, a 3,3-dimethylbutyl group, a 2-ethylbutyl group, a 1-methylhexyl group, a 4-tert-butylcyclohexyl group, an n-heptyl group, a 2-methylheptyl group, and an n-octyl group.

In the hole transporting compound according to the present disclosure, R³ and R⁴ may have an alkyl group having 1 or more and 4 or less carbon atoms as a substituent. To improve the solubility of the hole transporting compound according to the present disclosure and the miscibility thereof with the surrounding materials or the like, R³ and R⁴ can have an alkyl group having 1 or more and 4 or less carbon atoms as a substituent. Because R³ and R⁴ are directly bonded to the benzene ring of the fluorene, an excessively long carbon chain increases the inhibitory factors such as steric hindrance. Thus, the number of carbon atoms should be 1 or more and 4 or less. Specifically, examples of such groups include a methyl group, an ethyl group, an n-propyl group, an isopropyl group, an n-butyl group, an isobutyl group, a sec-butyl group, and a tert-butyl group.

The hole transporting compound according to the present disclosure has R¹¹ between the benzene ring and a polymerizable functional group as represented in Formula (1).

It is believed that this partial structure affects the energy value of the molecular orbital of the hole transporting compound. In particular, the highest occupied molecular orbital (HOMO) of the molecular orbital is related with the hole transportability, and the highest occupied molecular orbital within an appropriate range is important for the hole transportability.

Furthermore, the hole transporting compound should have physical properties within specific ranges from the viewpoint of injection and transport of holes to the surface layer under a specific environment, i.e., under a low temperature and low humidity environment.

In other words, under the conditions such as the low temperature and low humidity environment where the hole injection and transportability are readily reduced, the optimization of the values of the physical properties of the hole transporting compound contained in the surface layer can provide favorable injection and transport of charges from the adjacent hole transporting layer.

Although the details of the mechanism are not revealed, it is believed that the surface layer according to the present application effectively improves the potential variation generated by slightly stagnated charges accumulated at the interface between the hole transporting layer and the surface layer and within the surface layer during use for continuous printing. It is inferred that as in the present disclosure, the synergetic effect is demonstrated by the hole transporting compound having a fluorene structure where the conjugated structure widely and planarly extends, and having values of the specific physical properties within appropriate ranges.

The alkylene group represented as R¹¹ in Formula (1) should be an alkylene group having 2 or more and 6 or less carbon atoms. If the alkylene group represented by R¹¹ has one or less carbon atoms, the values of the physical properties of the hole transporting compound, such as the HOMO, are out of the appropriate ranges, resulting in a reduction in electrical properties as the photosensitive member. If the number of carbon atoms is 0, other defects may occur, for example, the polymerization reaction does not progress well. If the number of carbon atoms is more than 6, the alkyl group is excessively bulky near the arylamine structure, remarkably reducing the electrical properties.

The number of carbon atoms for R¹¹ is more preferably 2 or 3, and a propylene group is more preferred. It is believed that if the number of carbon atoms of the alkylene group is more than 6, the alkyl group near the aromatic amine structure is excessively long, reducing the hole transportability.

Thus, examples of the alkylene group include an ethylene group, an n-propylene group, an iso-propylene group, an n-butylene group, an iso-butylene group, an sec-butylene group, a tert-butylene group, an n-pentylene group, a 1-methyl-n-butylene group, a 2-methyl-n-butylene group, a 3-methyl-n-butylene group, a 1,1-dimethyl-n-propylene group, a 1,2-dimethyl-n-propylene group, a 2,2-dimethyl-n-propylene group, an n-hexylene group, a 1-methyl-n-pentylene group, a 2-methyl-n-pentylene group, a 1,1-dimethyl-n-butylene group, and a 1,2-dimethyl-n-butylene group.

In Formula (1), the substitution position for the amino group in the fluorene structure is preferably the 2-position or the 4-position of the fluorene from the viewpoint of easiness of the synthesis of the compound and the electrical properties of the photosensitive member. In particular, a structure having a substitution at the 2-position is preferred.

R¹³ represents a hydrogen atom, an alkyl group having 1 or more and 4 or less carbon atoms, an alkoxy group having 1 or more and 4 or less carbon atoms, a phenyl group, or a benzyl group.

Next, the compound represented by Formula (2) copolymerized with the hole transporting compound according to the present disclosure will be described.

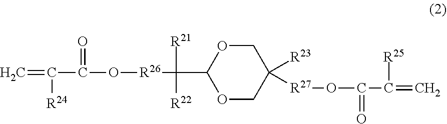

(where R²¹ and R²² each independently represent an alkyl group having 1 or more and 4 or less carbon atoms, or a substituted or unsubstituted aryl group; the substituent included in the aryl group is an alkyl group having 1 or more and 4 or less carbon atoms; R²¹ and R²² may be bonded to each other to form a ring; R²³ represents an alkyl group having 1 or more and 4 or less carbon atoms; R²⁴ and R²⁵ each independently represent a hydrogen atom or a methyl group; R²⁶ and R²⁷ each independently represent an alkylene group having 1 or more and 4 or less carbon atoms).

The compound represented by Formula (2) has no hole transportability. The compound represented by Formula (2) used in combination with the hole transporting compound having a structure represented by Formula (1) can provide a high level of compatibility between the prevention of image deletion under a high temperature and high humidity and the prevention of a potential variation during continuous printing under a low temperature and low humidity.

It is inferred that the compound represented by Formula (2) has an appropriately small molecular weight and has effects of improving the density of the film and preventing invasion of moisture from the environment. Because the compound represented by Formula (2) has an appropriately small molecular weight and has an action to supplementally increase the number of polymerizable functional groups, it has effects of reinforcing the film strength and improving the durability.

R²¹ and R²² each independently represent an alkyl group having 1 or more and 4 or less carbon atoms, or a substituted or unsubstituted aryl group. A substituent included in the aryl group is an alkyl group having 1 or more and 4 or less carbon atoms. Examples thereof include a methyl group, an ethyl group, an n-propyl group, an isopropyl group, an n-butyl group, an isobutyl group, a sec-butyl group, and a tert-butyl group.

R²¹ and R²² are preferably an alkyl group having 1 to 4 carbon atoms to attain the effects of the present application. This results in a compact molecular weight, facilitating an improvement in density of the film.

R²¹ and R²² may be bonded to each other to form a ring. If a ring is formed, examples thereof include a cyclopentane ring, a cyclohexane ring, and a cycloheptane ring. R²³ is an alkyl group having 1 or more and 4 or less carbon atoms. To attain the effects according to the present disclosure, the alkyl group for R²³ is preferably a methyl group or an ethyl group.

R²⁶ and R²⁷ each independently represent an alkylene group having 1 or more and 4 or less carbon atoms.

It is allowable that the mass of the hole transporting compound represented by Formula (1) included in the coating solution for a surface layer containing the composition of the surface layer is 0.5 times or more and 10 times or less the mass of the compound represented by Formula (2) contained in the composition. The mass is preferably 0.7 times or more and 4.0 or less, more preferably 1.0 times or more and 3.0 times or less.

The charge transportability, the electrical properties, and the durability potential variation of the surface layer can be maintained at a higher level by adjusting the mass ratio of the hole transporting compound represented by Formula (1) to the compound represented by Formula (2) in the coating solution for a surface layer.

The hole transporting compound represented by Formula (1) and the compound represented by Formula (2) can be polymerized by a method such as a method of giving energy such as ultraviolet light, electron beams, or heat or a method of causing compounds such as supplements (such as polymerization initiators), acids, alkalis, and complexes to coexist.

The compounds represented by Formula (1) and Formula (2) preferably have an acryloyloxy group or a methacryloyloxy group as a polymerizable functional group from the viewpoint of the wear resistance of the surface layer and the polymerization reaction rate during polymerization. Accordingly, R¹², R²⁴, and R²⁵ represent a hydrogen atom or a methyl group.

Next, exemplary compounds of the hole transporting compound according to the present disclosure represented by Formula (1) will be listed below. It should be noted that the exemplary compounds are not limited to the following ones.

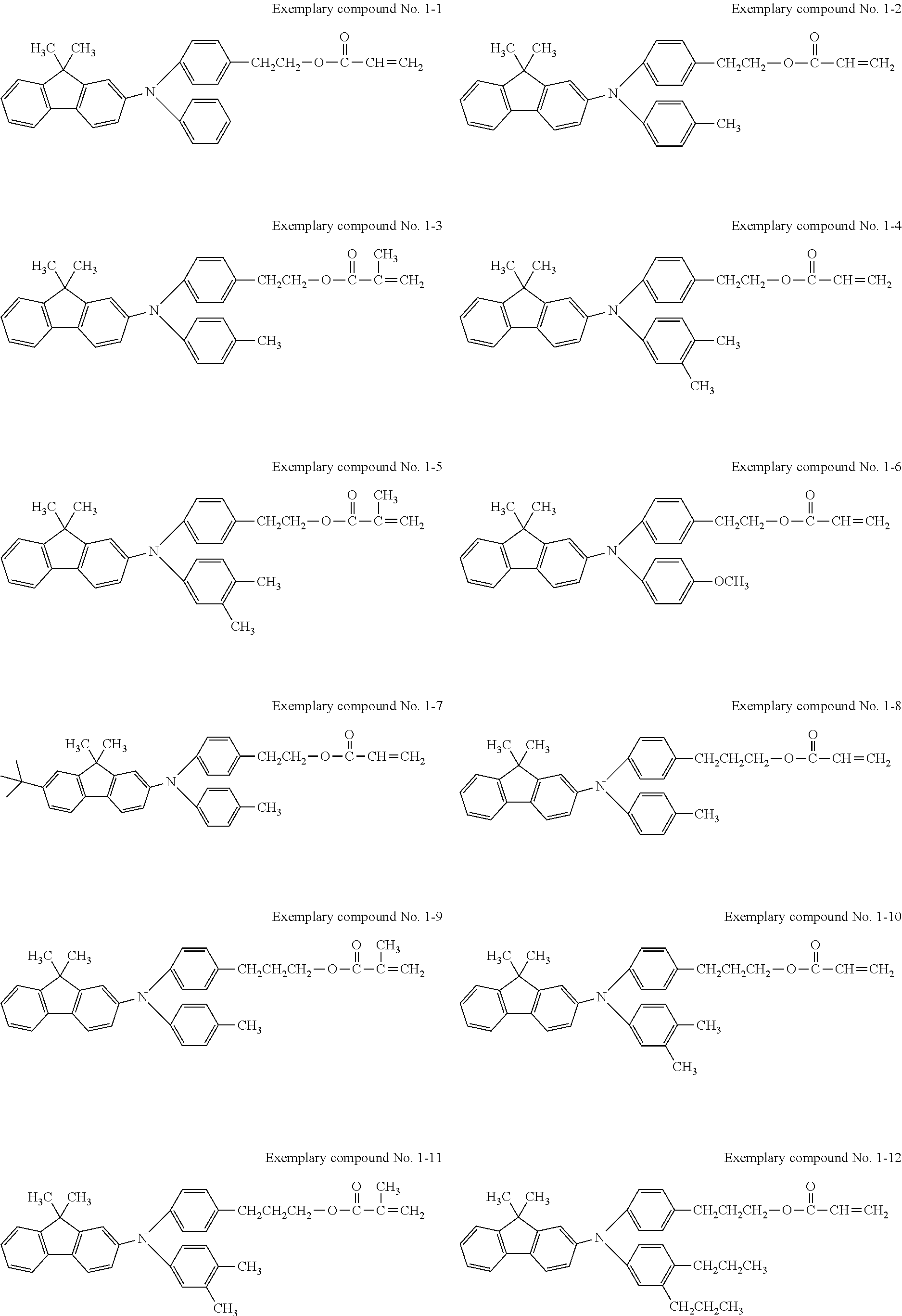

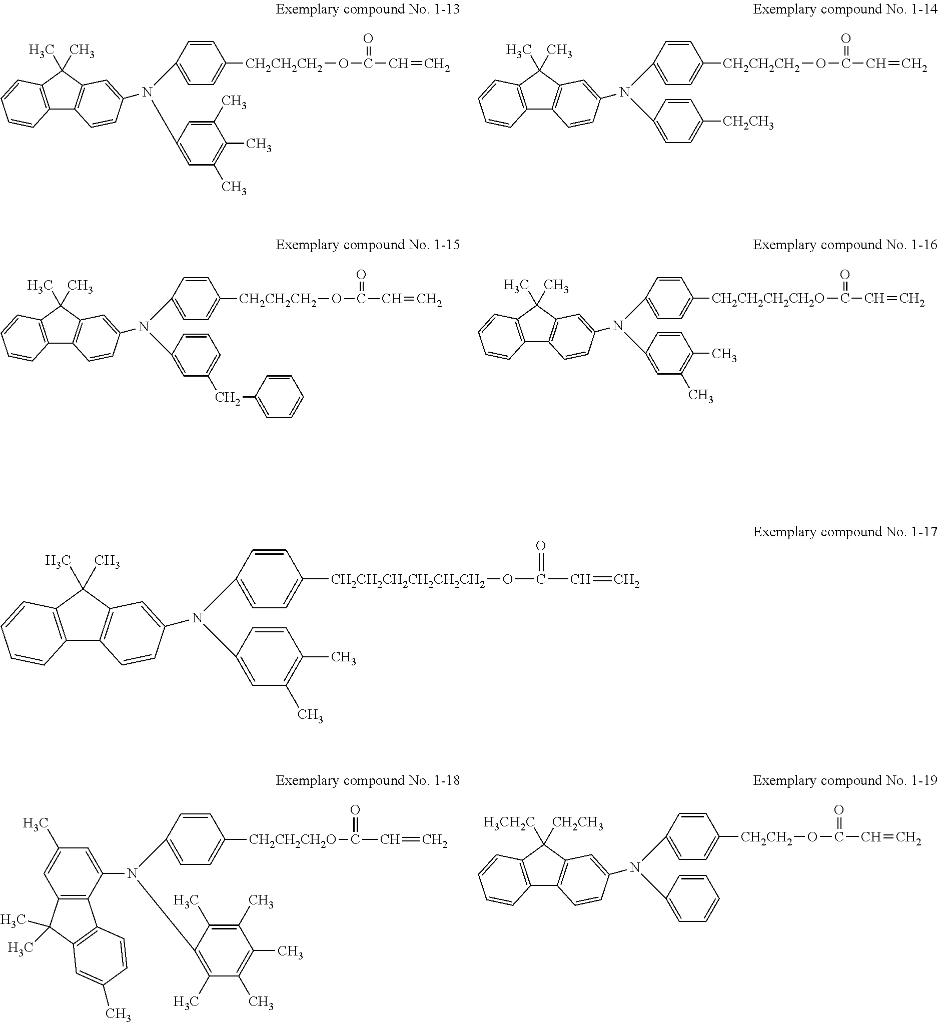

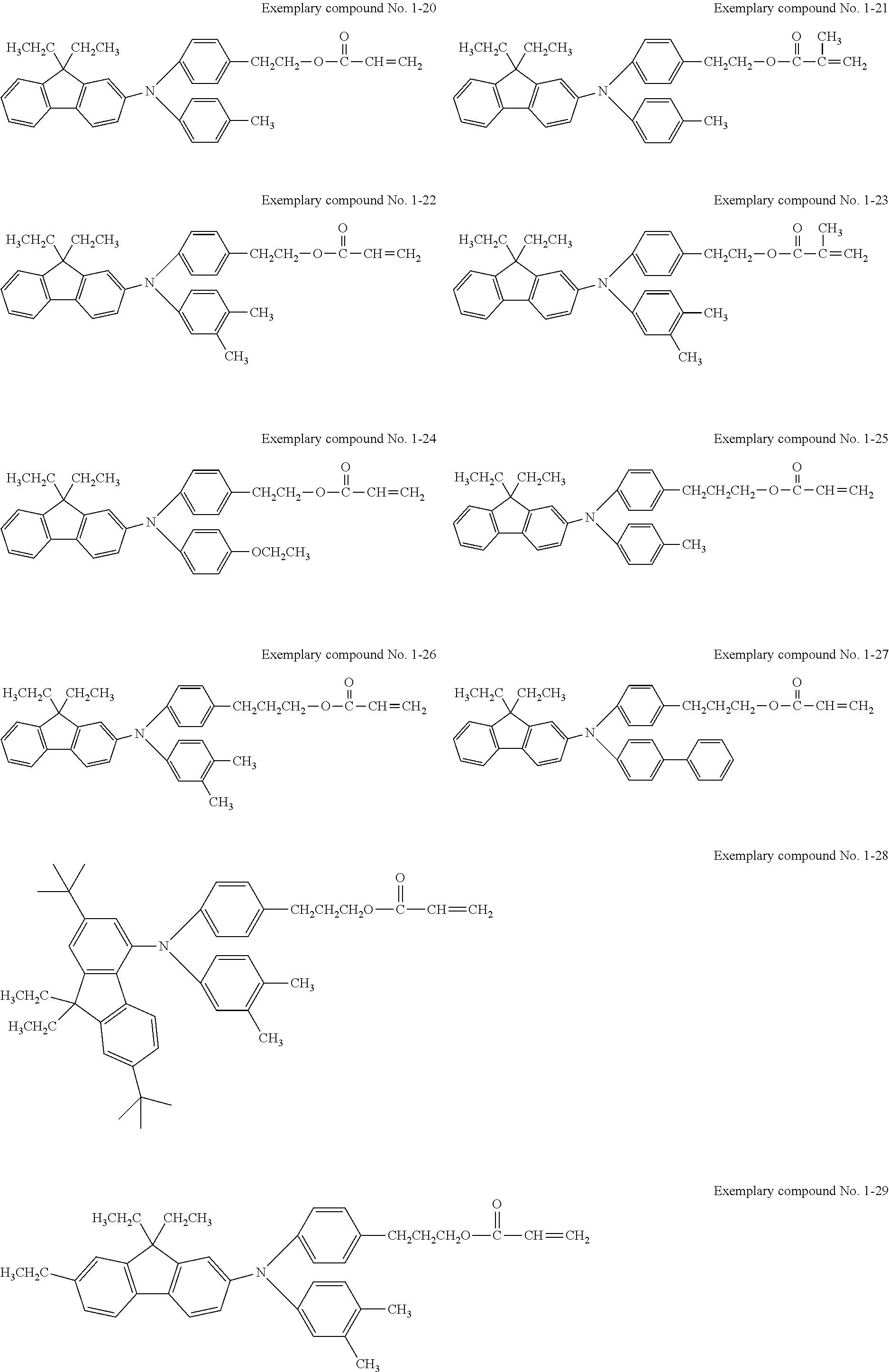

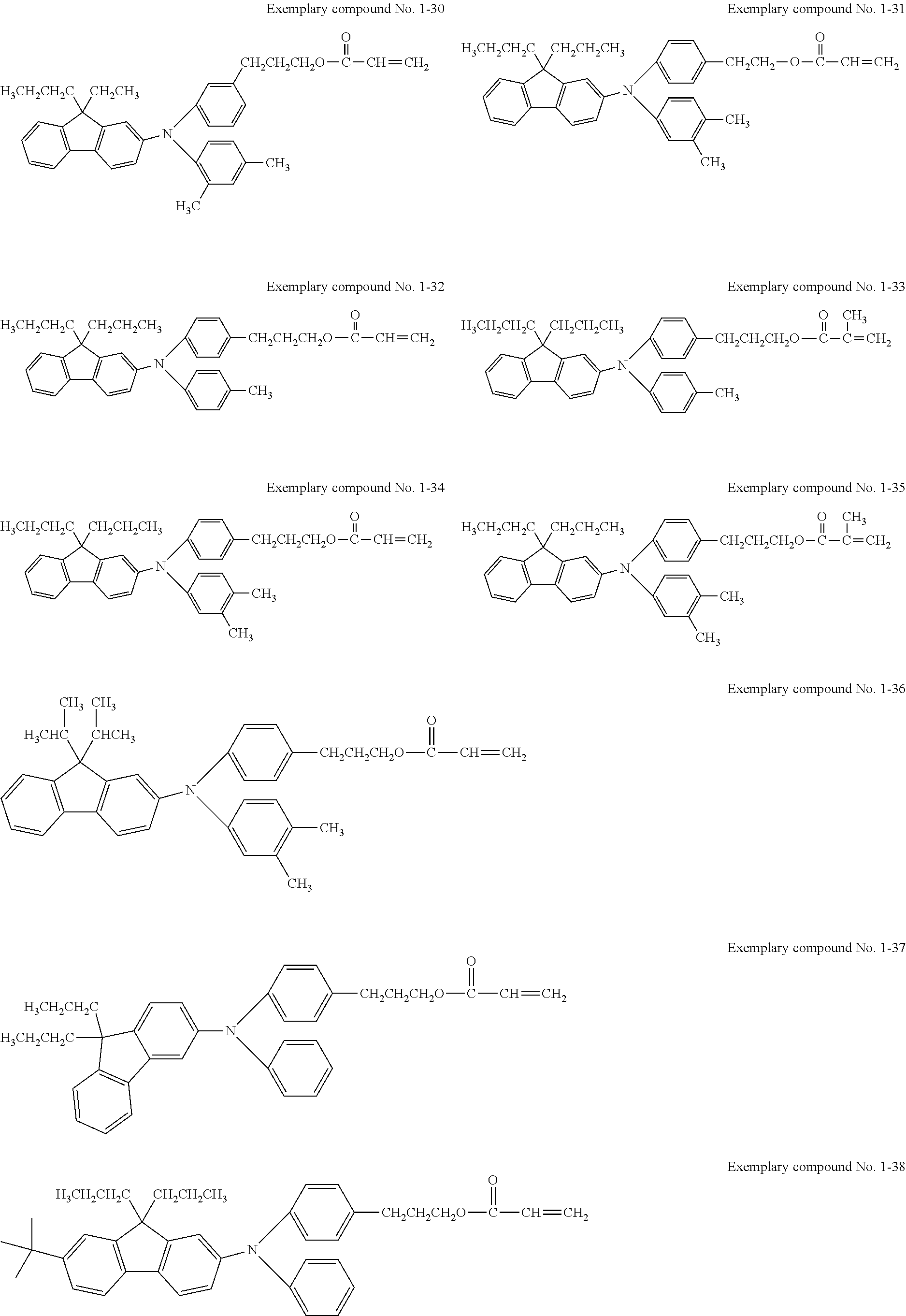

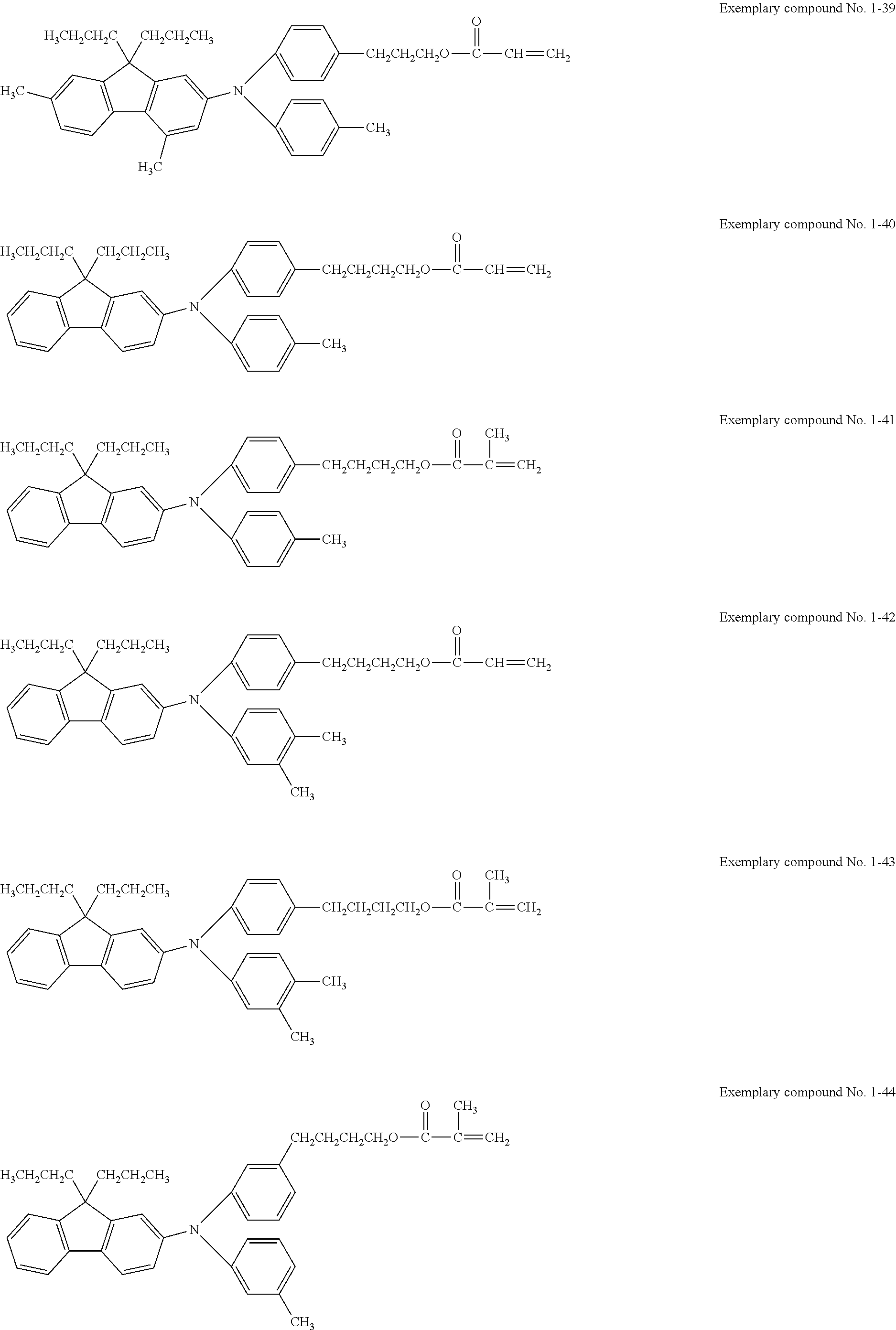

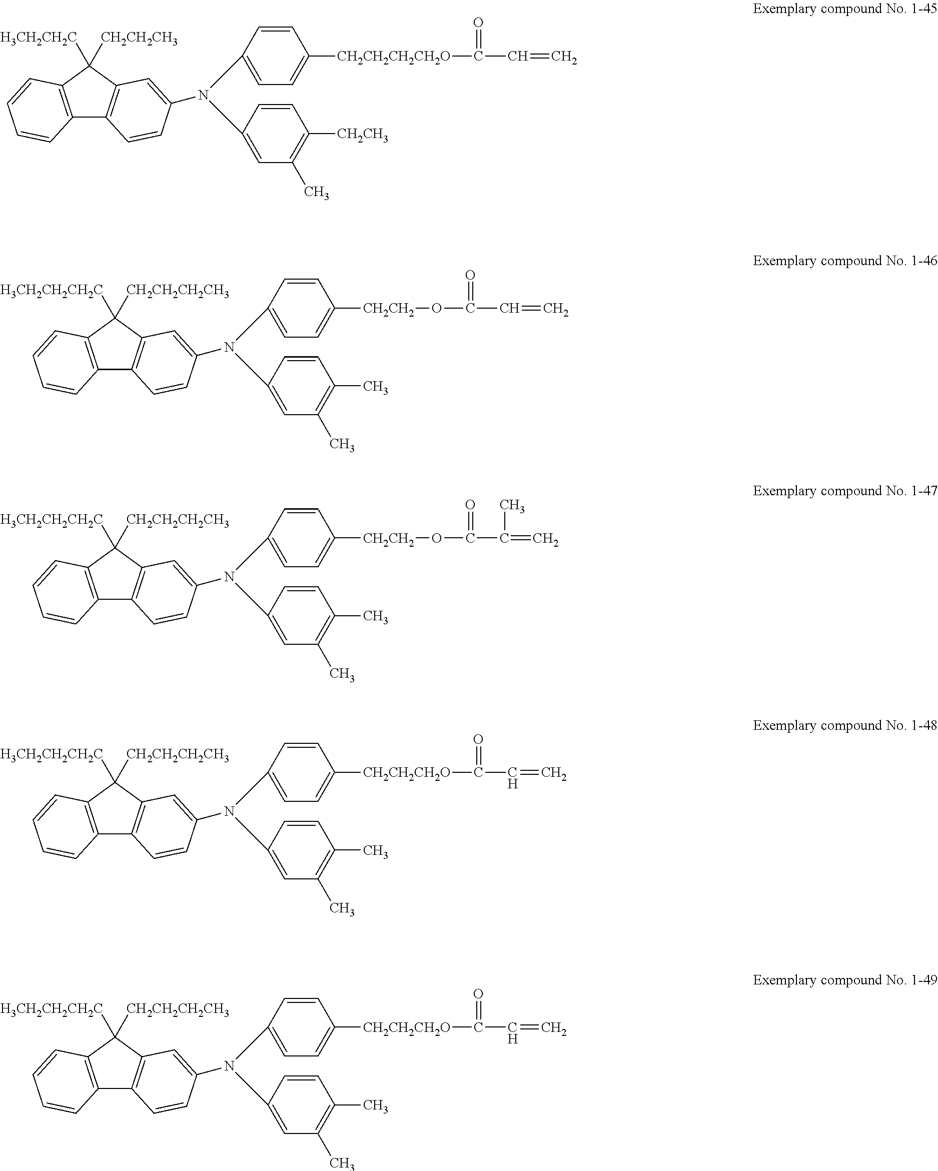

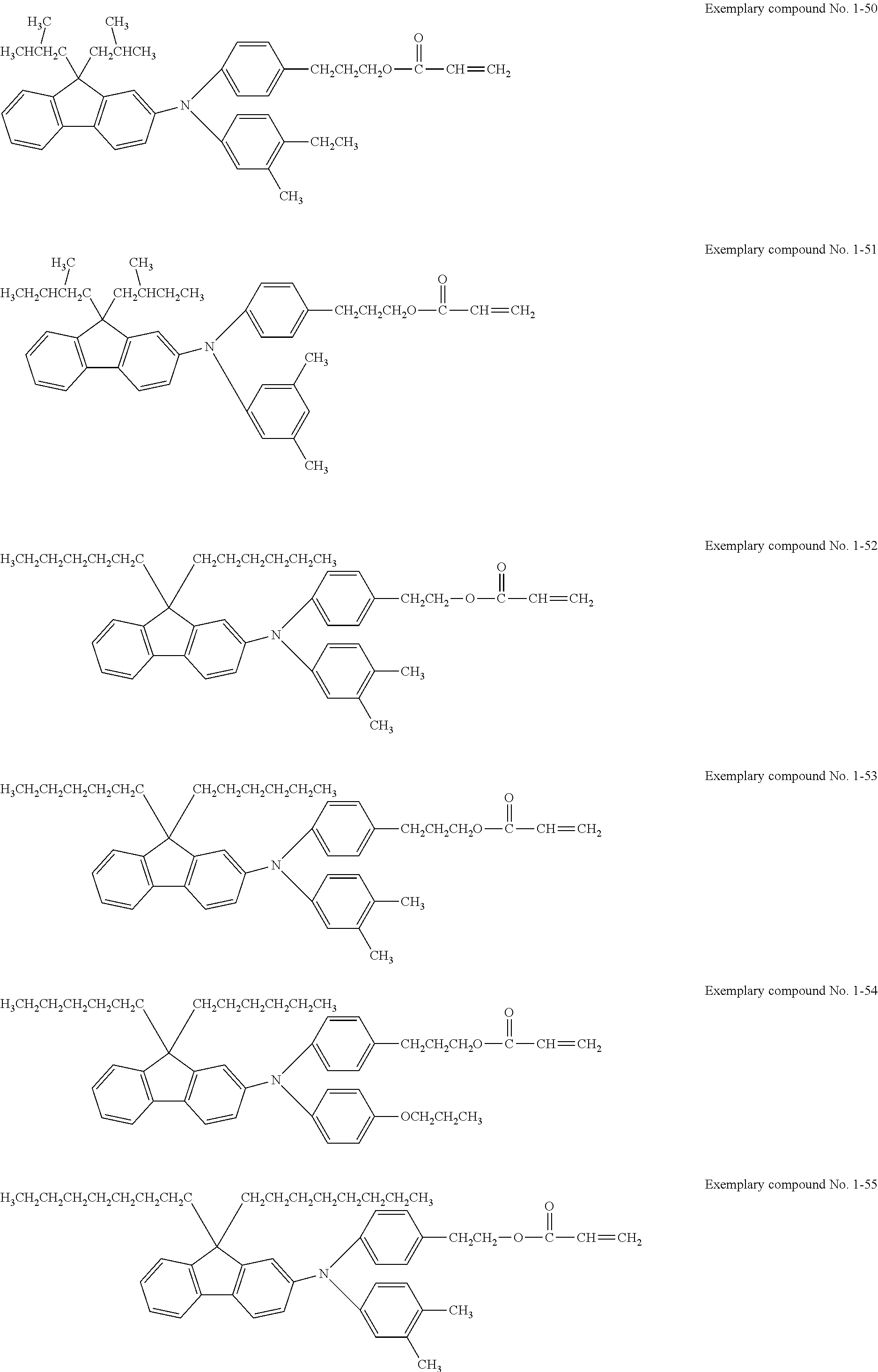

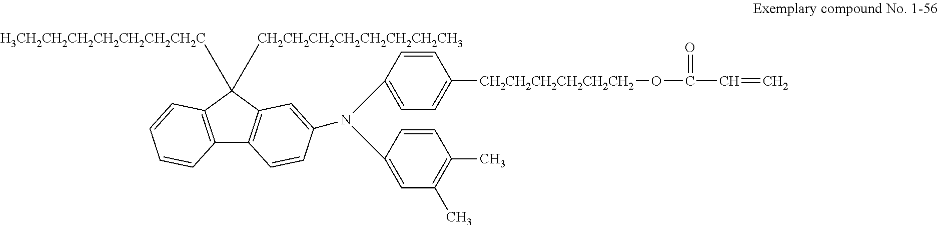

Examples of the compound represented by Formula (2) will be listed below. It should be noted that the examples are not limited to the followings.

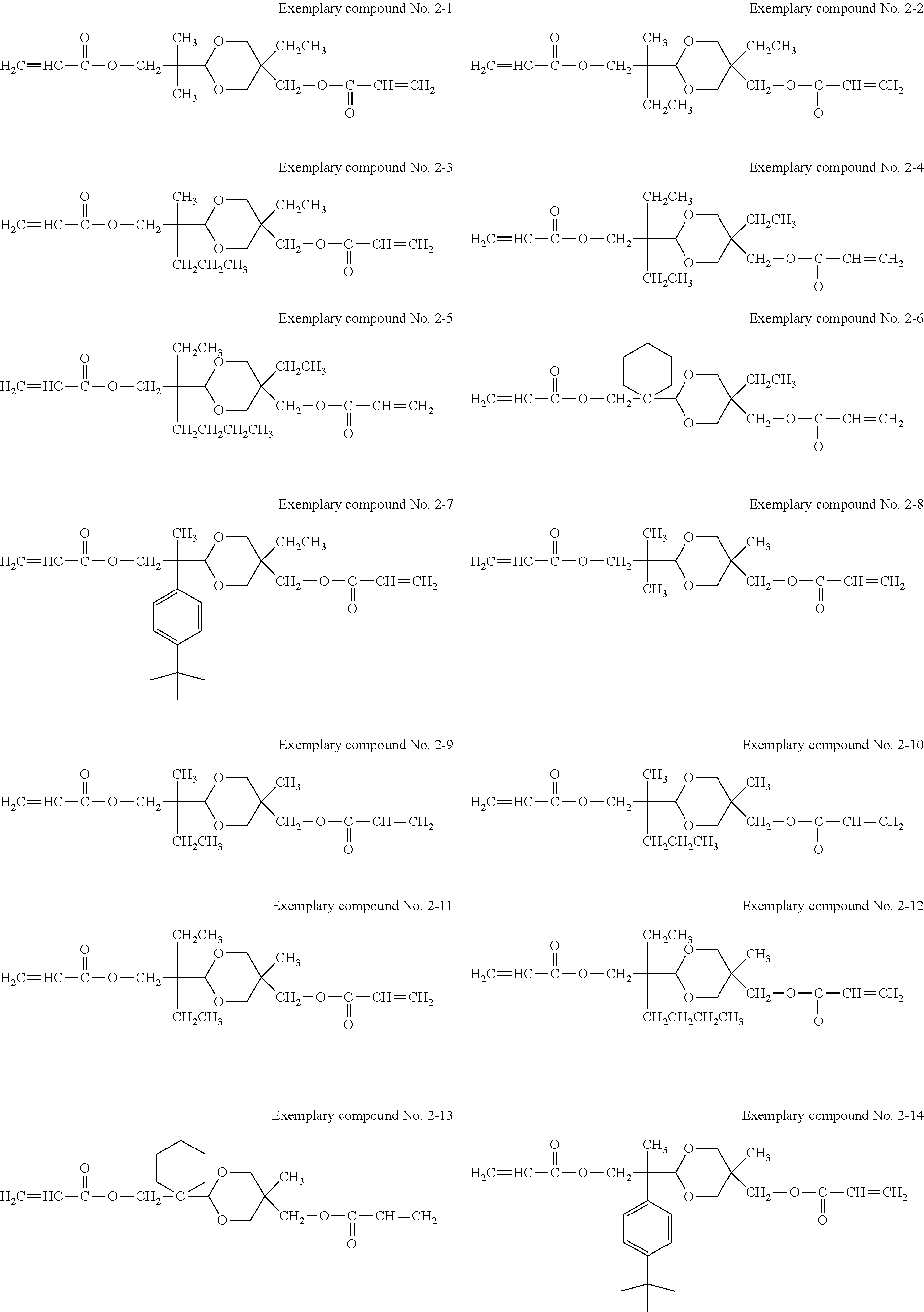

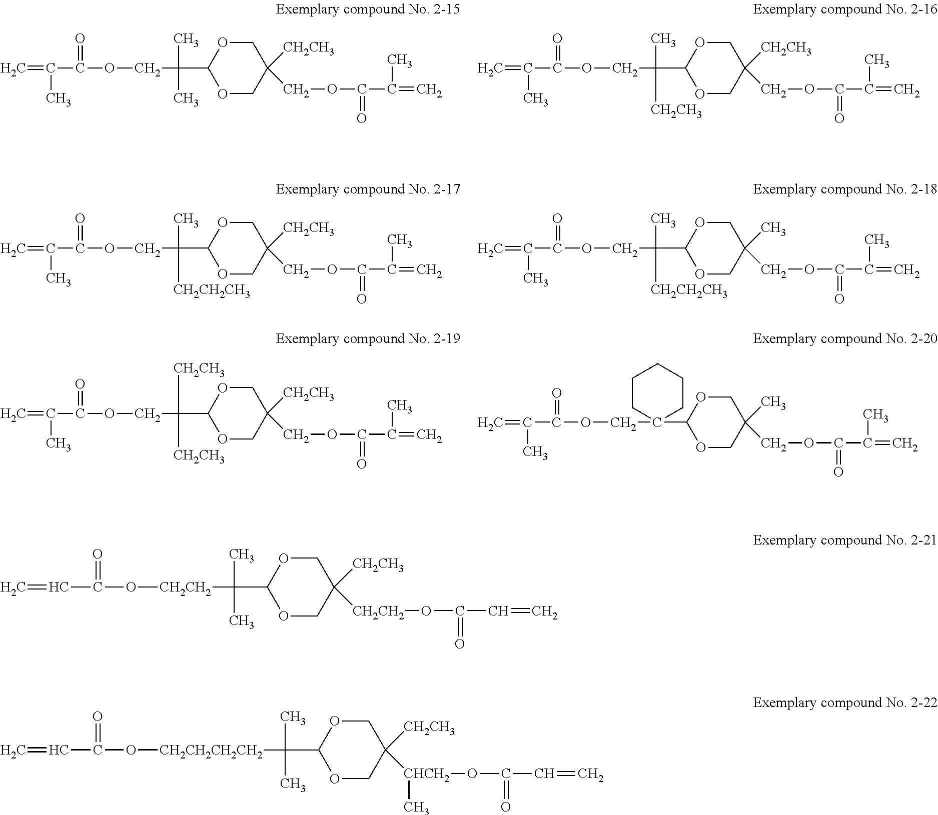

Furthermore, the photosensitive layer of the electrophotographic photosensitive member according to the present disclosure may be a laminate of a charge-generating layer, a hole transporting layer, and a surface layer disposed sequentially from the support. In this case, the hole transporting layer can contain at least one compound selected from a hole transporting compound represented by Formula (3) or a hole transporting compound represented by Formula (4):

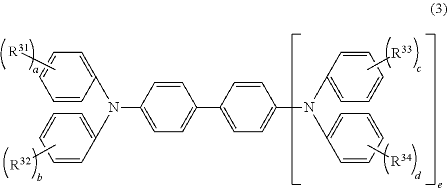

(where R³¹ to R³⁴ each independently represent a hydrogen atom or an alkyl group having 1 or more and 4 or less carbon atoms; a, b, c, and d represent 0 to 5; e represents 0 or 1).

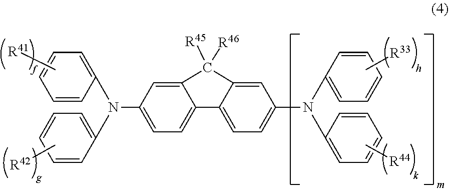

(where R⁴¹ to R⁴⁴ each independently represent a hydrogen atom or an alkyl group having 1 or more and 4 or less carbon atoms; R⁴⁵ and R⁴⁶ each independently represent an alkyl group having 1 or more and 8 or less carbon atoms; f, g, h, and k represent 0 to 5; m represents 0 or 1).

Next, examples of the compounds represented by Formulae (3) and (4) will be listed below. It should be noted that the examples are not limited to the followings.

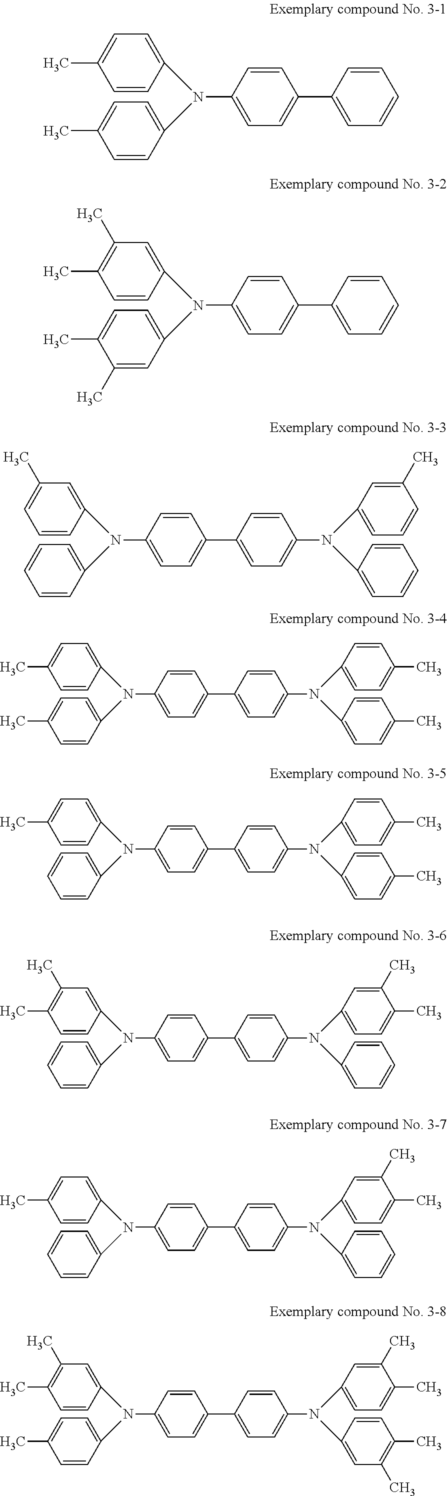

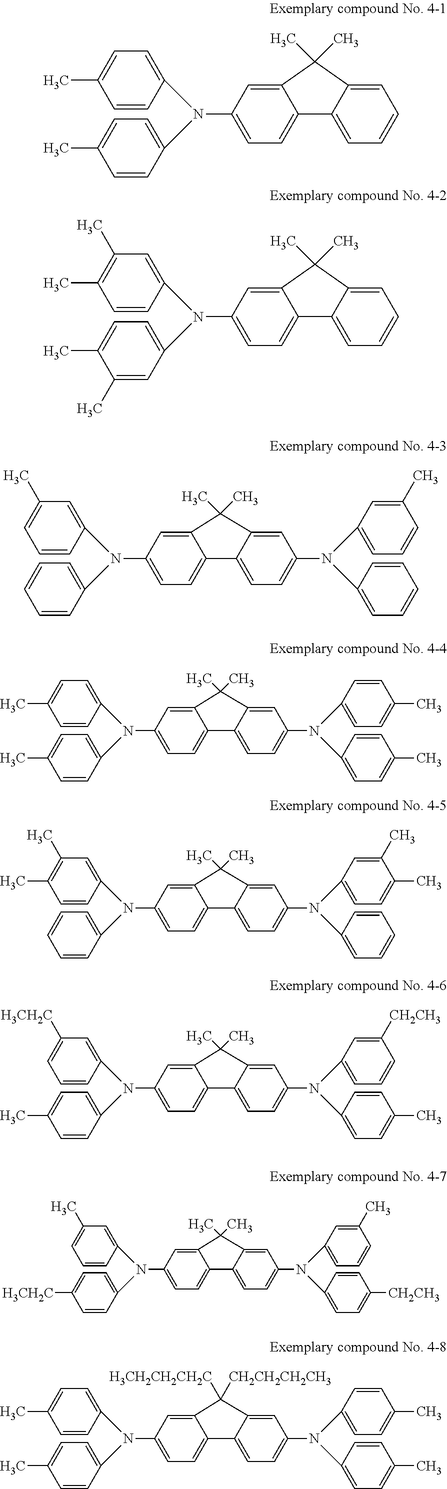

Representative Synthetic Examples of the hole transporting compound used in the present disclosure will be listed below.

### Synthetic Example 1

A synthetic example of the hole transporting compound represented by Exemplary compound No. 1-34 having a monofunctional polymerizable acrylic group will be shown.

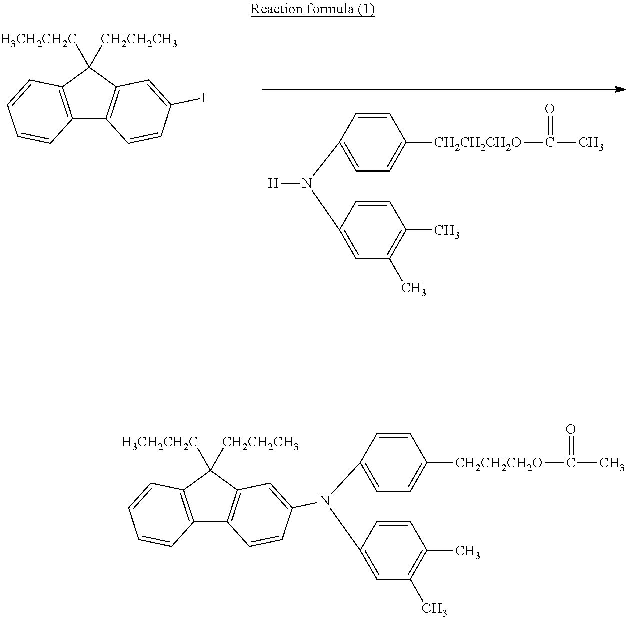

An iodide form and an amine compound represented in Reaction formula (1) were used to synthesize a triarylamine form. After 69.9 parts of the iodide form, 46.0 parts of the amine form in Formula, and 72 parts of o-dichlorobenzene were mixed in a reaction container, 23.5 parts of potassium carbonate and 11.8 parts of copper powder were added to perform a reaction at an inner temperature of about 210° C. Stirring was performed for about 24 hours to perform the reaction. After the reaction, filtration, washing with toluene, and condensation were performed to yield a crude product.

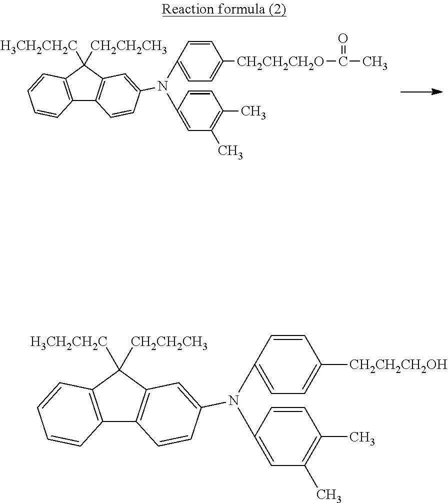

Subsequently, the resulting intermediate product was hydrolyzed to substitute an acetate ester group with a hydroxyl group. 85 parts of tetrahydrofuran, 85 parts of methanol, and 60 parts of 24% sodium hydroxide aqueous solution were mixed and heated to an inner temperature of 60° C. The reaction was performed under stirring for 1 hour, and hydrolysis was performed. After the reaction, the product was extracted from the reaction mixture with ethyl acetate, and the organic layer was subjected to washing with water, washing with saline water, dehydration, and condensation. The product was purified by silica gel chromatography to yield a dihydroxy intermediate product. yield: 52.4 parts, yield (two stages): 67.3%

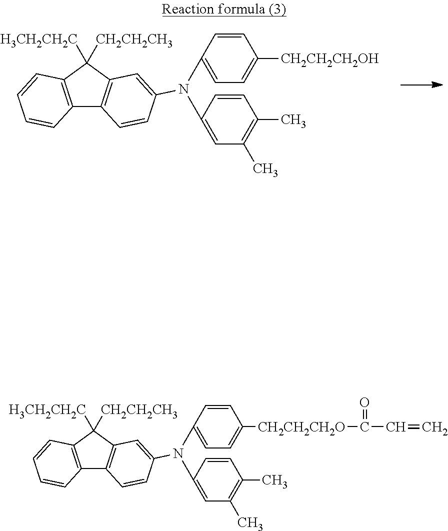

50.0 parts of the dihydroxy intermediate product yielded from the reaction above, 380 parts of toluene, and 0.95 parts of 4-methoxyphenol were mixed, and 8.6 parts of acrylic acid was placed into the reaction container. 1.0 part of p-toluenesulfonic acid monohydrate was added, and the reaction solution was heated for 6 hours under a 112° C. reflux condition to perform acrylization reaction.

After the reaction, the reaction solution was cooled, and a 10% sodium hydroxide aqueous solution was placed thereinto to neutralize the solution, followed by extraction with ethyl acetate. Washing with water, dehydration, and condensation were performed to yield a crude product.

Subsequently, the crude product was purified by silica gel column chromatography to yield a hole transporting compound having a polymerizable functional group. yield: 51.2 parts, yield: 92.5%

Furthermore, the kind and amount of the solvent for the resulting hole transporting compound were adjusted to prepare a varnish. Similarly, other hole transporting compounds represented by Formula (1) can be synthesized.

### Synthetic Example 2

A synthetic example of a bifunctional polymerizable acrylic group compound represented by Exemplary compound No. 2-3 will be shown.

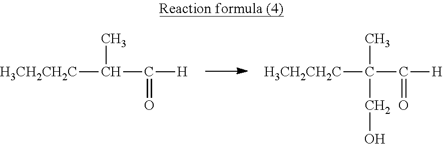

50 parts of 2-methylvaleraldehyde, 40.5 parts of 37% formaldehyde, and 8.5 parts of benzyltrimethylammonium hydroxide (40% aqueous solution) were mixed in an autoclave. The pressure was increased with nitrogen to 0.5 MPa, and the reaction solution was stirred at 90° C. for 1 hour. After the reaction was completed, the reaction solution was cooled to room temperature and separated. The reaction solution was washed with water and condensed to prepare about 50 parts of a colorless liquid.

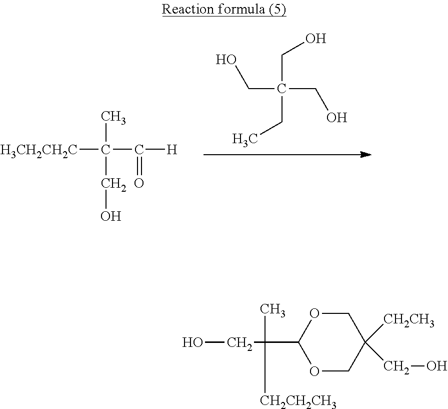

50 parts of the colorless liquid, 52 parts of trimethylolpropane, and 1 part of p-toluenesulfonic acid were mixed. The solution was stirred at room temperature overnight. After the reaction was completed, the reaction product was purified by column chromatography (silica gel was used, mobile phase: ethyl acetate) to yield about 30 parts of a colorless oil product.

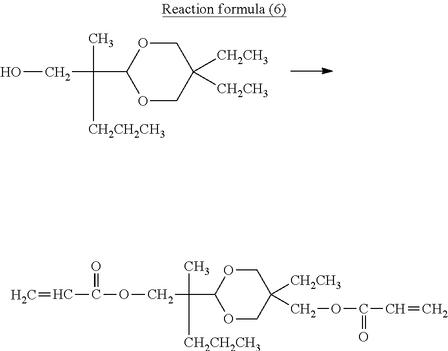

The colorless oil product underwent dehydration condensation with acrylic acid using chloroform as a solvent, triethylamine as a catalyst, and dicyclohexyl carbodiimide as a dehydration condensing agent. The filtrate of the reaction product was condensed and purified by column chromatography (silica gel was used, mobile phase: n-hexane/ethyl acetate=4/1) to yield a colorless liquid product. 100 ppm of 4-methoxyphenol as a polymerization inhibitor was added to perform preparation.

Similarly, other polymerizable compounds represented by Formula (2) can be synthesized.

Furthermore, the hole transporting compound having a polymerizable functional group according to the present disclosure and a hole transporting compound having a known polymerizable functional group may be contained in the range not inhibiting the target effects of the present disclosure. Aromatic amine compounds may be used as the hole transporting compound having a known polymerizable functional group.

The surface layer for the electrophotographic photosensitive member according to the present disclosure can contain a polymerization product of a mixed composition including another compound having a polymerizable functional group and having no hole transportability. Use thereof in combination with a substance having another polymerizable functional group can further improve the mechanical strength of the resulting polymerization product.

In the present disclosure, besides, the polymerizable functional group included in the compound having a polymerizable functional group and having no hole transportability may be the polymerizable functional group above. Preferably, radically polymerizable functional groups such as a styryl group, a vinyl group, an acryloyloxy group, and a methacryloyloxy group are preferred. More preferably, a radically polymerizable reaction group such as an acryloyloxy group or a methacryloyloxy group is preferred.

The surface layer may contain a variety of fine particles from the viewpoint of the wear resistance. The fine particles may be inorganic fine particles or may be organic fine particles. As the inorganic fine particles, particles containing alumina, silica, zinc oxide, tin oxide, or titanium oxide are used.

As the organic fine particles, fine particles of a variety of organic resins can be used. Examples of the organic resins include a polyolefin resin, a poly(tetrafluoroethylene) resin, a polystyrene resin, a poly(acrylic acid ester) resin, a poly(methacrylic acid ester) resin, a polyamide resin, a polyester resin, and a polyurethane resin.

The surface layer can be formed by forming a coating of a coating solution for a surface layer containing the hole transporting compound according to the present disclosure, and drying and/or curing the coating.

The solvent used in the coating solution for a surface layer can be alcohol solvents, sulfoxide solvents, ketone solvents, ether solvents, ester solvents, aliphatic halogenated hydrocarbon solvents, aliphatic hydrocarbon solvents, and aromatic hydrocarbon solvents.

If the surface layer is a protective layer, the surface layer preferably has a film thickness of 0.1 μm or more and 15 μm or less. If the surface layer is a hole transporting layer, the surface layer preferably has a film thickness of 5 μm or more and 40 μm or less.

Examples of the method of curing the coating of the coating solution for a surface layer (polymerizing the hole transporting compound according to the present disclosure) include a method of polymerizing the coating using heat, light (such as ultraviolet light), or radiation rays (such as electron beams). Among these, radiation rays are preferred. Among the radiation rays, electron beams are more preferred.

Polymerization using electron beams preferably results in a very dense (highly dense) three-dimensional network structure and improves the wear resistance. It also results in high productivity because an efficient polymerization reaction is performed in a short time. In the case of irradiation with electron beams, examples of an accelerator include those of a scanning type, an electrocurtain type, a broad beam type, a pulse type, and a laminar type.

If the electron beam is used, the electron beam preferably has an accelerating voltage of 150 kV or less to prevent the degradation of the material properties by the electron beam without impairing the polymerization efficiency. The electron beam absorption dose on the surface of the coating of the coating solution for a surface layer is preferably 5 kGy or more and 50 kGy or less, more preferably 10 kGy or more and 30 kGy or less.

If the hole transporting compound according to the present disclosure is polymerized using the electron beam, preferably, the compound is irradiated with the electron beam in an inert gas atmosphere, and is heated in the inert gas atmosphere in order to prevent the polymerization inhibiting action by oxygen. Examples of the inert gas include nitrogen, argon, and helium.

Next, the entire configuration of the electrophotographic photosensitive member according to the present disclosure will be described.

[Electrophotographic Photosensitive Member]

A preferred configuration of the electrophotographic photosensitive member according to the present disclosure is a configuration of a laminate of a support, a charge-generating layer, and hole transporting layer sequentially disposed. As needed, an electro-conductive layer and/or an undercoat layer may be disposed between the charge-generating layer and the support, or a protective layer may be disposed on the hole transporting layer. In the present disclosure, the charge-generating layer and the hole transporting layer are collectively referred to as a photosensitive layer.

The hole transporting compound according to the present disclosure is contained in the surface layer. The surface layer according to the present disclosure indicates the protective layer if the electrophotographic photosensitive member includes the protective layer, and indicates the hole transporting layer if the protective layer is not included. The photosensitive layer may be composed of a single-layer photosensitive layer containing a charge generating substance and the hole transporting compound.

<Support>

The support is preferably an electrically conductive support made of a material having conductivity. Examples of the material for the support include metals or alloys thereof such as iron, copper, gold, silver, aluminum, zinc, titanium, lead, nickel, tin, antimony, indium, chromium, aluminum alloy, and stainless steel. Alternatively, a metal support or a resin support having a coating film formed through vacuum deposition of aluminum, an aluminum alloy, or an indium oxide-tin oxide alloy can also be used. Alternatively, a support prepared by impregnating a plastic or paper with conductive particles such as carbon black, tin oxide particles, titanium oxide particles, or silver particles or a support containing a conductive resin can also be used. Examples of the shape of the support include cylindrical shapes, belt-like shapes, sheet shapes, or platy shapes. The cylindrical shapes are most common.

The surface of the support may be subjected to a treatment such as a machining treatment, a surface roughening treatment, or an anodized aluminum treatment to prevent interference fringes caused by scattering of laser light, improve surface defects of the support, and improve the conductivity of the support.

<Electro-Conductive Layer>

An electro-conductive layer may be disposed between the support and the undercoat layer or the charge-generating layer described later to prevent interference fringes caused by scattering of laser and control the resistance or coat scratches of the support.

The electro-conductive layer can be formed by applying a coating solution for an electro-conductive layer prepared by dispersing carbon black, a conductive pigment, and a resistance adjusting pigment together with a binder resin, and drying the resulting coating. The coating solution for an electro-conductive layer may contain a compound curable and/or polymerizable through heating, irradiation with ultraviolet light, or irradiation with radiation rays. The electro-conductive layer formed by dispersing the conductive pigment and the resistance adjusting pigment tends to have a rough surface.

The electro-conductive layer has a film thickness of preferably 0.1 μm or more and 50 μm or less, more preferably 0.5 μm or more and 40 μm or less, still more preferably 1 μm or more and 30 μm or less.

Examples of the binder resin used in the electro-conductive layer include polymers and copolymers of vinyl compounds such as styrene, vinyl acetate, vinyl chloride, acrylic acid ester, methacrylic acid ester, vinylidene fluoride, and trifluoroethylene, poly(vinyl alcohol) resins, poly(vinyl acetal) resins, polycarbonate resins, polyester resins, polysulfone resins, poly(phenylene oxide) resin, polyurethane resins, cellulose resins, phenol resins, melamine resins, silicon resins, epoxy resins, and isocyanate resins.

Examples of the conductive pigment and the resistance adjusting pigment include particles of metals (alloys) such as aluminum, zinc, copper, chromium, nickel, silver, and stainless steel, and those deposited on surfaces of plastic particles. Particles of metal oxides such as zinc oxide, titanium oxide, tin oxide, antimony oxide, indium oxide, bismuth oxide, or tin-doped indium oxide, or antimony- or tantalum-doped tin oxide may also be used. These may be used alone or in combination.

<Undercoat Layer>

An undercoat layer (intermediate layer) may be disposed between the support or the electro-conductive layer and the charge-generating layer to improve the adhesiveness of the charge-generating layer, the hole injection properties from the support, and protect the charge-generating layer against electrical breakdown.

The undercoat layer can be formed by applying a coating solution for an undercoat layer prepared by dissolving a binder resin in a solvent, and drying the coating.

Examples of the binder resin used in the undercoat layer include poly(vinyl alcohol) resin, poly-N-vinylimidazole, polyethylene oxide resin, ethyl cellulose, ethylene-acrylic acid copolymers, casein, polyamide resins, N-methoxymethylated 6 nylon resin, copolymerized nylon resins, phenol resins, polyurethane resins, epoxy resins, acrylic resins, melamine resins, or polyester resins.

The undercoat layer may further contain metal oxide particles. Examples of the metal oxide particles include particles containing titanium oxide, zinc oxide, tin oxide, zirconium oxide, or aluminum oxide. The metal oxide particles may be metal oxide particles having surfaces treated with a surface treatment agent such as a silane coupling agent.

The undercoat layer has a film thickness of preferably 0.05 μm or more and 30 μm or less, more preferably 1 μm or more and 25 μm or less. The undercoat layer may further contain organic resin fine particles and a leveling agent.

<Charge-Generating Layer>

Next, the charge-generating layer will be described. The charge-generating layer can be formed by applying a coating solution for a charge-generating layer prepared by dispersing a charge generating substance with a binder resin and a solvent to form a coating, and drying the coating. The charge-generating layer may be a deposition film of a charge generating substance.

Examples of the charge generating substance used in the charge-generating layer include azo pigments, phthalocyanine pigments, indigo pigments, perylene pigments, polycyclic quinone pigments, squarylium dyes, pyrylium salts, thiapyrylium salts, triphenylmethane dyes, quinacridone pigments, azulenium salt pigments, cyanine dyes, anthanthrone pigments, pyranthrone pigments, xanthene dyes, quinoneimine dyes, and styryl dyes. These charge generating substances may be used alone or in combination. Among these charge generating substances, phthalocyanine pigments and azo pigments are preferred, and in particular, phthalocyanine pigments are more preferred from the viewpoint of sensitivity.

Among these phthalocyanine pigments, particularly, oxytitanium phthalocyanines, chlorogallium phthalocyanines, and hydroxygallium phthalocyanines have high charge generating efficiency. Furthermore, among these hydroxygallium phthalocyanines, hydroxygallium phthalocyanine crystals are more preferred from the viewpoint of sensitivity, the crystals having peaks at the Bragg angle 2θ of 7.4°±0.3° and 28.2°±0.3° in the CuKα properties X-ray diffraction.

Examples of the binder resin used in the charge-generating layer include polymers of vinyl compounds such as styrene, vinyl acetate, vinyl chloride, acrylic acid ester, methacrylic acid ester, vinylidene fluoride, and trifluoroethylene, poly(vinyl alcohol) resins, poly(vinyl acetal) resins, polycarbonate resins, polyester resins, polysulfone resins, poly(phenylene oxide) resins, polyurethane resins, cellulose resins, phenol resins, melamine resins, silicon resins, and epoxy resins.

The mass ratio of the charge generating substance to the binder resin is preferably in the range of 1:0.3 to 1:4.

The charge-generating layer has a film thickness of preferably 0.05 μm or more and 1 μm or less, more preferably 0.1 μm or more and 0.5 μm or less.

<Hole Transporting Layer>

Next, the hole transporting layer will be described. If the hole transporting layer is the surface layer, as described above, the hole transporting layer contains the polymerization product of the hole transporting compound according to the present disclosure.

On the other hand, if a protective layer is disposed on the hole transporting layer, the hole transporting layer can be formed by forming a coating of a coating solution for a hole transporting layer prepared by mixing a hole transporting compound and a binder resin in a solvent, and drying the coating. The hole transporting compound and the binder resin used in the hole transporting layer will now be described.

Examples of the hole transporting compound include carbazole compounds, hydrazone compounds, N,N-dialkylaniline compounds, diphenylamine compounds, triphenylamine compounds, triphenylmethane compounds, pyrazoline compounds, styryl compounds, and stilbene compounds.

Examples of the binder resin include acrylic acid esters, methacrylic acid esters, poly(vinyl alcohol) resins, poly(vinyl acetal) resins, polycarbonate resins, and polyester resins. Curable resins such as curable phenol resins, curable urethane resins, curable melamine resins, curable epoxy resins, curable acrylic resins, and curable methacrylic resins can also be used.

Examples of the solvent used in the coating solution for a hole transporting layer include alcohol solvents, sulfoxide solvents, ketone solvents, ether solvents, ester solvents, aliphatic halogenated hydrocarbon solvents, and aromatic hydrocarbon solvents.

The hole transporting layer has a film thickness of preferably 1 μm or more and 100 μm or less, more preferably 3 μm or more and 50 μm or less, still more preferably 5 μm or more and 40 μm or less.

A variety of additives can be contained to the layers of the electrophotographic photosensitive member according to the present disclosure. Specifically, examples thereof include organic pigments, organic dyes, coating surface adjusters, electron transport agents, oil, wax, antioxidants, light absorbers, polymerization initiators, radical deactivating agents, organic resin fine particles, and inorganic particles.

The surfaces of the layers of the electrophotographic photosensitive member may be surface treated using a polishing sheet, a shape transfer mold member, glass beads, or zirconia beads. Alternatively, depressions and projections may be formed on the surfaces thereof using constitutional materials of the coating solutions. When the coating solutions for the layers above are applied, a known coating method such as an immersion coating method, a spray coating method, a circular amount regulating mold (ring) coating method, a spin coating method, a roller coating method, a Meyer bar coating method, or a blade coating method can also be used, for example.

[Process Cartridge]

Next, a process cartridge including the electrophotographic photosensitive member according to the present disclosure and an image forming process will be described.

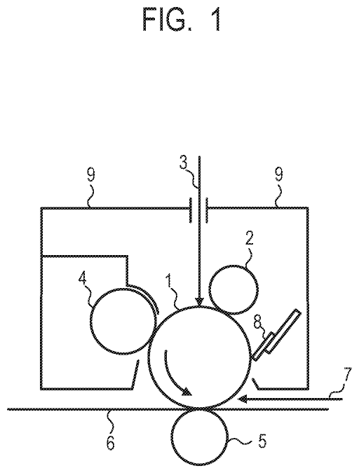

The configuration of the process cartridge according to one aspect of the present disclosure is shown in FIG. 1. In FIG. 1, a cylindrical electrophotographic photosensitive member 1 is driven to rotate in the arrow direction at a predetermined circumferential speed. The circumferential surface of the electrophotographic photosensitive member 1 driven to rotate is uniformly charged to a positive or negative predetermined potential by a charging unit 2. In the next step, the circumferential surface of the charged electrophotographic photosensitive member 1 receives exposing light (image exposing light) 3 output from an exposure unit (not illustrated) using slit exposure or laser beam scanning exposure. Thus, electrostatic latent images corresponding to a target image are sequentially formed on the circumferential surface of the electrophotographic photosensitive member 1. The voltage applied to the charging unit (such as a charging roller) 2 may be a voltage of an AC component superimposed on a DC component, or a voltage of only a DC component.

The electrostatic latent image formed on the circumferential surface of the electrophotographic photosensitive member 1 is developed with a toner contained in a developer in developing unit 4 to form a toner image. In the next step, the toner image carried on the circumferential surface of the electrophotographic photosensitive member 1 is sequentially transferred onto a transfer material (such as paper or an intermediate transfer member) 6 by the transfer bias from a transfer unit (such as a transfer roller) 5. The transfer material 6 is fed in synchronization with the rotation of the electrophotographic photosensitive member 1.

The surface of the electrophotographic photosensitive member 1 after the toner image transfer is discharged by pre-exposing light 7 from a pre-exposure unit (not illustrated), and then a transfer residual toner is removed by a cleaning unit 8 to clean the surface. The electrophotographic photosensitive member 1 is repeatedly used in the formation of the image. The pre-exposure may be performed before or after the cleaning step, or is not always needed.

The electrophotographic photosensitive member 1 may be mounted on an electrophotographic apparatus such as a copier or a laser beam printer. Alternatively, among the components such as the electrophotographic photosensitive member 1, the charging unit 2, the developing unit 4, and the cleaning unit 8, some of them may be accommodated in a container, and may be integrally supported by a process cartridge 9, which may be detachable attached to the body of the electrophotographic apparatus. In FIG. 1, the process cartridge 9 integrally supports the electrophotographic photosensitive member 1, the charging unit 2, the developing unit 4, and the cleaning unit 8, and is detachable from the body of the electrophotographic apparatus.

[Electrophotographic Apparatus]

Next, the electrophotographic apparatus according to the present disclosure will be described.

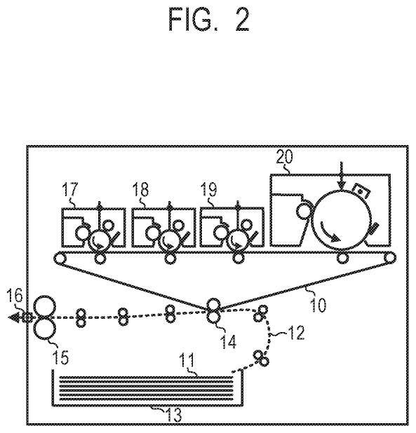

The configuration of the electrophotographic apparatus according to one aspect of the present disclosure is shown in FIG. 2. A yellow process cartridge 17, a magenta process cartridge 18, a cyan process cartridge 19, and a black process cartridge 20 corresponding to colors of yellow, magenta, cyan, and black, respectively, are aligned along an intermediate transfer member 10. As shown in FIG. 2, the diameter and constitutional material of the electrophotographic photosensitive member, the developer, the charge method, and other units do not always be the same among the process cartridges of the respective colors. For example, in the electrophotographic apparatus shown in FIG. 2, the electrophotographic photosensitive member in the black process cartridge has a diameter larger than those of the color (yellow, magenta, and cyan) process cartridges. While the color process cartridges use a charge method of applying a voltage of an AC component superimposed on a DC component, the black process cartridge uses corona discharge.

When the image forming operation starts, the toner images of the respective colors are sequentially layered on the intermediate transfer member 10 according to the image forming process described above. In parallel, transfer paper 11 is sent from a paper feed tray 13 by a paper feed path 12, and is fed to a secondary transfer unit 14 in synchronization with the timing of the rotational operation of the intermediate transfer member. The toner images on the intermediate transfer member 10 are transferred onto the transfer paper 11 by the transfer bias from the secondary transfer unit 14. The toner images transferred onto the transfer paper 11 are conveyed along the paper feed path 12, and are fixed onto the transfer paper by a fixing unit 15. The transfer paper is then discharged from a paper discharge unit 16.

### Advantageous Effects of Invention

As described above, the present disclosure can provide an electrophotographic photosensitive member which has high image deletion prevention properties under a high temperature and high humidity environment, and further has high potential variation properties during continuous long-term use under a low temperature and low humidity environment, and a method of manufacturing the electrophotographic photosensitive member. In addition, the present disclosure can provide an electrophotographic apparatus including the electrophotographic photosensitive member, and a process cartridge including the electrophotographic photosensitive member.

### EXAMPLES

Hereinafter, the electrophotographic photosensitive member according to the present disclosure will be described in more detail by way of specific Examples. In Examples, “parts” means “parts by mass”. Hereinafter, the electrophotographic photosensitive member is also simply referred to as “photosensitive member”.

<Preparation of Electrophotographic Photosensitive Member>

### Example 1

A cylindrical aluminum cylinder having an outer diameter of 30.0 mm, a length of 357.5 mm, and a thickness of 0.7 mm was used as a support (electrically conductive support).

Next, 10 parts of zinc oxide particles (specific surface area: 19 m²/g, powder resistivity: 4.7×10⁶Ω·cm) were mixed with 50 parts of toluene with stirring, and 0.08 parts of a silane coupling agent was added thereto, followed by stirring for 6 hours. Subsequently, toluene was removed under reduced pressure, and drying by heating at 130° C. for 6 hours was performed to yield surface-treated zinc oxide particles. The silane coupling agent used was KBM602 (compound name: N-2-(aminoethyl)-3-aminopropylmethyldimethoxysilane) made by Shin-Etsu Chemical Co., Ltd.

Next, 15 parts of a poly(vinyl butyral) resin (weight average molecular weight: 40000, trade name: BM-1, made by Sekisui Chemical Co., Ltd.) and 15 parts of blocked isocyanate (trade name: Duranate TPA-B80E, made by Asahi Kasei Chemicals Corporation) were prepared. These were dissolved in a mixed solution of 73.5 parts of methyl ethyl ketone and 73.5 parts of 1-butanol. 80.8 parts of the surface-treated zinc oxide particles and 0.8 parts of 2,3,4-trihydroxybenzophenone (made by Wako Pure Chemical Industries, Ltd.) were added to the solution, and the solution was dispersed for 3 hours under a 23±3° C. atmosphere in a sand mill apparatus using glass beads having a diameter of 0.8 mm. After the dispersion, 0.01 parts of silicone oil (trade name: made by SH28PA, Dow Corning Toray Co., Ltd.) and 5.6 parts of crosslinking poly(methyl methacrylate) (PMMA) particles (trade name: TECHPOLYMER SSX-102, made by SEKISUI PLASTICS CO., Ltd., average primary particle diameter of 2.5 μm) were added and stirred to prepare a coating solution for an undercoat layer.

The coating solution for an undercoat layer was applied onto the support through immersion coating to form a coating, and the coating was dried at 160° C. for 40 minutes to form an undercoat layer having a film thickness of 18 μm.

Next, 2 parts of hydroxygallium phthalocyanine crystal (charge generating substance) was prepared. The crystals had peaks where the Bragg angle 20±0.2 was 7.4° and 28.2° in CuKα properties X-ray diffraction. Furthermore, 0.02 parts of a calixarene compound represented by the following structural formula (A), 1 part of poly(vinyl butyral) (trade name: S-LEC BX-1, made by Sekisui Chemical Co., Ltd.), and 60 parts of cyclohexanone were prepared. These were placed into a sand mill using glass beads having a diameter of 1 mm and dispersed for 4 hours. Subsequently, 70 parts of ethyl acetate was added to prepare a coating solution for a charge-generating layer. The coating solution for a charge-generating layer was applied onto an undercoat layer through immersion coating, and the coating was dried at 90° C. for 15 minutes to form a charge-generating layer having a film thickness of 0.17 μm.

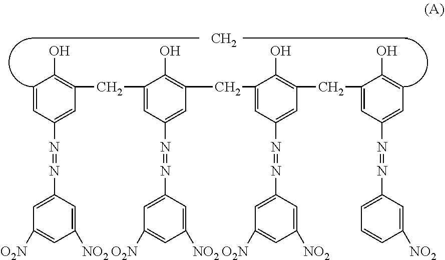

Next, the following materials were prepared.

For the compound represented by Formula (3), 6 parts of a compound represented by the following structural formula (B):

For the compound represented by Formula (4), 3 parts of the compound represented by the following structural formula (C):

1 part of a compound represented by the following structural formula (D):

10 parts of a bisphenol Z polycarbonate resin (trade name: Iupilon Z400, made by Mitsubishi Engineering-Plastics Corporation)

These were dissolved in a mixed solvent of 35 parts of o-xylene, 35 parts of dimethoxymethane, and 30 parts of methyl benzoate to prepare a coating solution for a hole transporting layer. The coating solution for a hole transporting layer was applied onto the charge-generating layer through immersion coating, and the coating was dried at 110° C. for 50 minutes to form a hole transporting layer having a film thickness of 18 μm.

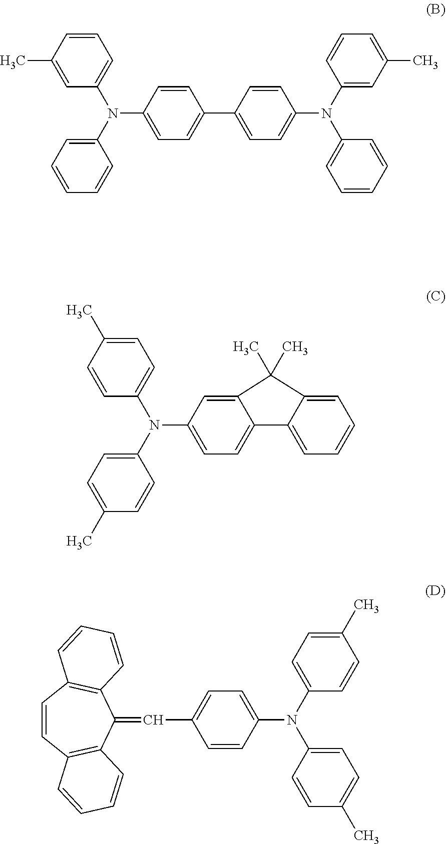

1.5 parts of a fluorine atom-containing acrylic resin (weight average molecular weight: 83,000, copolymerization ratio (F1)/(F2)=1/1 (molar ratio)) having a repeating structural unit represented by Formula (F1) and a repeating structural unit represented by Formula (F2):

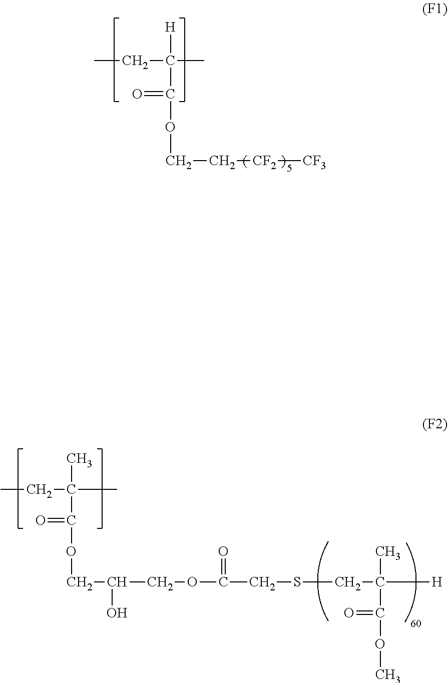

were dissolved in a mixed solvent of 45 parts of 1-propanol and 45 parts of ZEORORA H (made by ZEON Corporation). Subsequently, 30 parts of an ethylene fluoride resin powder (trade name: RUBURON L-2, made by DAIKIN INDUSTRIES, LTD.) was added, and the solution was dispersed with a high pressure dispersing machine (trade name: Microfluidizer M-110EH, made by Microfluidics Corporation, USA) to prepare an ethylene fluoride resin dispersion.

Next, 4 parts of a hole transporting compound represented by Exemplary compound No. 1-4, 1.6 parts of a compound represented by Exemplary compound No. 2-1, 8 parts of the ethylene fluoride resin dispersion solution, 3 parts of 1-propanol, and 3 parts of ZEORORA H were homogeneously dispersed with stirring to prepare a coating solution for a surface layer.

The coating solution for a surface layer was applied onto the hole transporting layer through immersion coating. The coating was dried at 50° C. for 10 minutes and subjected to a polymerization curing treatment through irradiation with electron beams and heating under the following condition.

While an aluminum cylinder was being rotated at a rate of 300 rpm in an atmosphere having an oxygen concentration of 50 ppm or less, the aluminum cylinder was irradiated with an electron beam using an electron beam irradiator on the following condition: an irradiation distance of 30 mm, an accelerating voltage of 70 kV, a beam current of 8 mA, and an irradiation time of 3.0 seconds. Immediately after the irradiation with the electron beam, the surface of the coating of the coating solution for a surface layer was heated to 135° C. over 24 seconds using an induced heater on the condition of an oxygen concentration of 50 ppm or less.

Next, the aluminum cylinder was extracted to an air atmosphere and further heated at 100° C. for 12 minutes to form a surface layer (protective layer) having a film thickness of 5 μm.

Next, a mold member (mold) was installed in a pressure welding shape transfer processing apparatus to perform a surface process on the electrophotographic photosensitive member before depressed portions were formed.

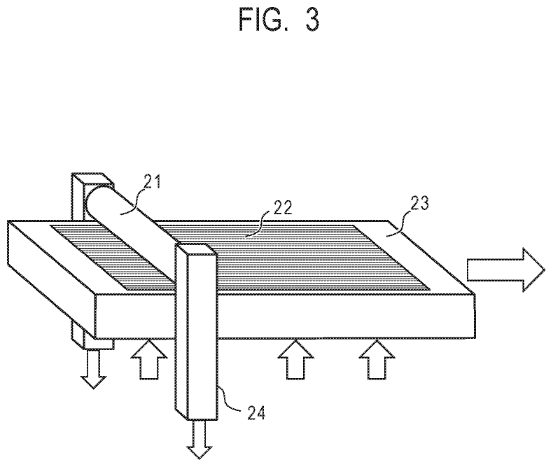

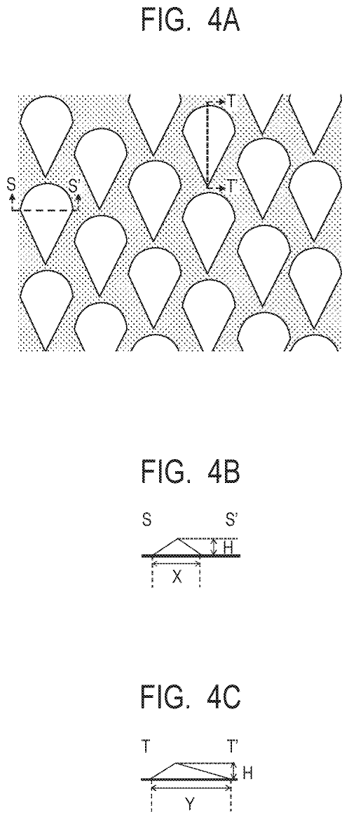

Specifically, in general, a mold shown in FIGS. 4A to 4C was installed in a pressure welding shape transfer processing apparatus having a configuration shown in FIG. 3 including a mold 22, a pressurizing member 23, and a supporting member 24, and a surface process was performed on the resulting electrophotographic photosensitive member 21 before depressed portions were formed.

FIGS. 4A to 4C are views illustrating the mold used in Examples and Comparative Examples. FIG. 4A is a schematic top view showing a mold, and FIG. 4B is a schematic cross-sectional view (cross-sectional view of the S-S′ cross-section in FIG. 4A) of a protrusion of the mold in the axis direction of the electrophotographic photosensitive member 21. FIG. 4C is a cross-sectional view (cross-sectional view of the T-T′ cross-section in FIG. 4A) of a protrusion of the mold in the circumferential direction of the electrophotographic photosensitive member 21. The molds shown in FIGS. 4A to 4C have a protrusion having a maximum width (the maximum width of the protrusion of the mold in the axis direction of the electrophotographic photosensitive member 21 when seen from above) X of 50 μm, a maximum length (the maximum length of the protrusion of the mold in the circumferential direction of the electrophotographic photosensitive member 21 when seen from above) Y of 75 μm, an area rate of 56%, and a height H of 4 μm.

The area rate refers to the ratio of the area of the protrusion in the entire surface when the mold is seen from above. During the process, the temperatures of the electrophotographic photosensitive member 21 and the mold were controlled such that the temperature of the surface of the electrophotographic photosensitive member 21 was 120° C. While the electrophotographic photosensitive member and the pressurizing member were being pressed against the mold at a pressure of 7.0 MPa, the electrophotographic photosensitive member 21 was rotated in the circumferential direction to form depressed portions on the entire surface of the surface layer (circumferential surface) of the electrophotographic photosensitive member 21. Thus, the electrophotographic photosensitive member 21 was produced.

The enlarged surface of the resulting electrophotographic photosensitive member 21 was observed with a 50× lens in a laser microscope (trade name: X-100, made by Keyence Corporation) to observe the depressed portions disposed on the surface of the electrophotographic photosensitive member 21. During the observation, adjustment was performed such that the electrophotographic photosensitive member 21 was not inclined in the longitudinal direction, and in the circumferential direction, the vertex of the arc of the electrophotographic photosensitive member 21 was in focus. The image enlarged and observed was connected through an image connecting application to yield a square region of 500 μm. For the result, the image treatment height data was selected by attached image analysis software, and a filter treatment was performed with a filter type median.

As a result of the observation, the depressed portion had a depth of 2 μm. The width of the opening in the axis direction was 50 μm, and the length of the opening in the circumferential direction was 75 μm. The area was 140000 μm². The area refers to the area of the depressed portion when the surface of the electrophotographic photosensitive member 21 is seen from above, and means the area of the opening of the depressed portion. Thus, a photosensitive member according to Example 1 was prepared.

### Examples 2 to 20, Comparative Examples 1 to 4

The hole transporting compounds shown in Table 1 were used instead of the hole transporting compound and the compound having no hole transportability, which were used in the preparation of the coating solution for a protective layer in Example 1. Except for that, photosensitive members according to Examples 2 to 20 and Comparative Examples 1 to 4 were prepared in the same manner as in Example 1. Comparative compounds No. 1 to 4 used in Comparative Examples 1 to 4 are shown below.

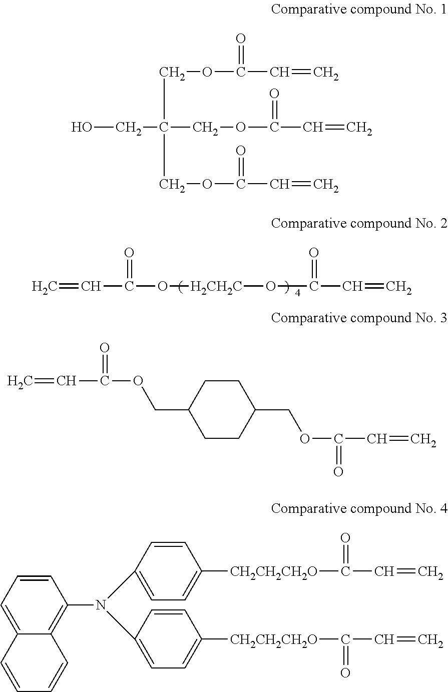

### Example 21

The following materials were prepared.

10 parts of a bisphenol Z polycarbonate resin (trade name: Iupilon Z400, made by Mitsubishi Engineering-Plastics Corporation)

10 parts of a compound represented by the following structural formula (G)

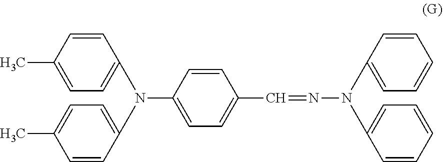 [SMILES: Cc1ccc(N(c2ccc(C)cc2)c2ccc(C=NN(c3ccccc3)c3ccccc3)cc2)cc1]

These were dissolved in a mixed solvent of 35 parts of o-xylene, 35 parts of dimethoxymethane, and 30 parts of methyl benzoate to prepare a coating solution for a hole transporting layer.

A hole transporting layer was formed on the charge-generating layer in the same manner as in Example 1 except that the coating solution for a hole transporting layer was replaced with the coating solution for a hole transporting layer prepared above.

In the next step, a surface layer (protective layer) was formed on the hole transporting layer in the same manner as in Example 1 using the compound represented by Formula (1) and the compound represented by Formula (2) shown in Table 1 to prepare an electrophotographic photosensitive member according to the present Example.

### Comparative Example 5

An electrophotographic photosensitive member was prepared in the same manner as in Example 1 except that the surface layer was formed as follows.

First, the following materials were prepared.

1 part of a compound represented by Comparative compound No. 5 below,

1 part of trimethylolpropane triacrylate (Comparative compound No. 6),

0.2 parts of 1-hydroxycyclohexylphenyl ketone as a polymerization initiator, and

0.2 parts of 2,2-bis(4,4-di-t-butylperoxycyclohexyl)propane,

58 parts of tetrahydrofuran as a coating material solvent

These were mixed to prepare a coating solution for a protective layer. The coating solution for a protective layer was applied onto the hole transporting layer through spray coating, and the coating was dried and subjected to a polymerization curing treatment on the same condition as that in Example 1 to form a protective layer.

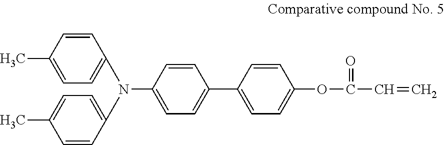 [SMILES: C=CC(=O)Oc1ccc(-c2ccc(N(c3ccc(C)cc3)c3ccc(C)cc3)cc2)cc1]

<Evaluation 1: Initial Sensitivity and Residual Potential>

The photosensitive members according to Examples 1 to 21 and Comparative Examples 1 to 5 were evaluated for the initial sensitivity and the residual potential on the following condition.

Using a photosensitive member tester (trade name: CYNTHIA59, made by GEN-TECH, Inc.), first, the condition of a charging apparatus was set such that the surface of the electrophotographic photosensitive member was −700 V under an environment at a temperature of 23° C. and a relative humidity of 50%. The surface of the photosensitive member charged to −700 V was irradiated with monochromatic light with a light quantity of 20 (μJ/cm²), and the potential of the surface of photosensitive member was measured. The measured potential was defined as a residual potential (−V). The results of evaluation are shown in Table 1.

<Evaluation 2: Evaluation of Image Deletion Under High Temperature and High Humidity Environment>

The image deletion was evaluated on the following condition using the photosensitive members according to Examples 1 to 21 and Comparative Examples 1 to 5.

As modifications made, the electrophotographic apparatus used was a full-color multifunction machine (trade name: iR-ADVC5560; made by Canon Inc.) modified so as to enable the adjustment and measurement of the image exposure laser power, the current amount (hereinafter, also referred to as the total current) which flows from the charging roller to the support of the electrophotographic photosensitive member, and the voltage applied to the charging roller. The charging apparatus used was a contact charging apparatus which included a rubber roller as a charging roller and was configured to superimpose an AC current on a DC current and apply the superimposed current to the charging roller. Furthermore, the heater of the body of the copier and the power supply of the cassette heater were turned off during use.

First, after the electrophotographic apparatus and the electrophotographic photosensitive members were left to stand in a high temperature and high humidity environment (temperature: 30° C., relative humidity: 80%) for 24 hours, the electrophotographic photosensitive members according to Examples and Comparative Examples each were mounted on a cyan cartridge of the electrophotographic apparatus.

Next, the voltage, where the DC component was −700 V and the frequency of the AC component was 1500 Hz, was applied to the charging roller from −400 V to −2000 V at an interval of an inter-peak potential Vpp of 100 V, and the total current at each Vpp value was measured. A graph was created with the Vpp value as the abscissa and the total current as the ordinate, and a Vpp value where the current amount (hereinafter, also referred to as a discharge current amount) deviating from the primary fitted curve at a Vpp value of −400 V to −800 V was 100 μA was determined. A Vpp value where the discharge current amount was 100 μA was set.

Next, the charge setting of the electrophotographic apparatus was set such that the dark potential was −700 V. A solid image was output onto a normal sheet of a size A4 with a single color of cyan, and the image exposing light amount was set such that the initial concentration on the sheet measured by a spectrodensitometer (trade name: X-rite504, made by X-rite, Inc.) was 1.45±0.05.

A square lattice image of a size A4, a line width of 0.1 mm, and a line interval of 10 mm was read from a scanner and continuously output onto 5000 sheets of paper with a single color of cyan. After the image was output, the main power supply of the electrophotographic apparatus was turned off, and the electrophotographic apparatus was left as it was for 3 days. After the electrophotographic apparatus was left, the main power supply of the electrophotographic apparatus was turned on, and immediately the square lattice image was output onto one sheet of paper. The image deletion of the output image was visually observed to evaluate the image deletion according to the following criteria.

The evaluation ranks were defined as follows.

Rank 6: the lattice image is clearly output.

Rank 5: The lattice image is not found to have any abnormality.

Rank 4: While the horizontal line of the lattice image is broken, the vertical line is not found to have any abnormality.

Rank 3: While the horizontal line of the lattice image disappears, the vertical line is not found to have any abnormality.

Rank 2: The horizontal line of the lattice image disappears, and the vertical line is broken.

Rank 1: The horizontal line of the lattice image disappears, and the vertical line also disappears.

At this time, the horizontal line of the lattice image indicates a line parallel to the cylinder axis direction of the photosensitive member, and the vertical line indicates a line vertical to the cylinder axis direction of the photosensitive member. The results of evaluation are shown in Table 1.

<Evaluation 3: Evaluation of Potential Variation During Repeated Used Under Low Temperature and Low Humidity Environment>

The photosensitive members according to Examples 1 to 21 and Comparative Examples 1 to 5 were evaluated for the potential variation during repeated use of the photosensitive members on the following condition under a low temperature and low humidity environment.

The electrophotographic apparatus used was a full-color multifunction machine (trade name: iR-ADVC5560; made by Canon Inc.) modified so as to enable adjustment of the potential charged from the charging roller to the photosensitive member and the power of the image exposure laser.

The electrophotographic apparatus and the electrophotographic photosensitive members were left to stand in a low temperature and low humidity environment (temperature: 15° C., relative humidity: 10%) for 48 hours, and then the electrophotographic photosensitive members each were mounted on the cyan cartridge of the electrophotographic apparatus.

The cartridge for developing was removed from the evaluation apparatus, and a potential measurement apparatus was inserted in that position to measure the surface potential of the electrophotographic photosensitive member. The potential measurement apparatus is configured to dispose a potential measuring probe in the developing position of the cartridge for developing. With respect to the electrophotographic photosensitive member, the potential measuring probe was located in the center of the cylindrical electrophotographic photosensitive member in the axis direction with a gap from the surface of the electrophotographic photosensitive member being 3 mm.

Adjustment was performed such that the AC component for the charging roller was 1500 Vpp and 1500 Hz, and the initial dark potential (VDa) was −700 V, and such that the initial bright potential (VLa) before the durability test by exposure of the image through irradiation with laser exposure was −200 V, and the set value was recorded. These operations were similarly performed in the electrophotographic photosensitive members to be evaluated.

An image of a band having an image density of 1% was printed, and 1000 sheets of paper were continuously fed. After the durability test was finished, immediately the bright potential (VLb) after feeding 1000 sheets of paper was measured using the potential measurement apparatus.

A variation between the initial bright potential (VLa) before feeding the sheets and the bright potential (VLb) thereafter was verified and defined as a bright potential variation ΔVL(ab). The results are shown in Table 1.

<Evaluation 4: Evaluation of Wear Amount>

The photosensitive members according to Examples 1 to 21 and Comparative Examples 1 to 5 were evaluated for the wear amount of the surface layer during repeated use on the following condition.

The electrophotographic apparatus used was a full-color multifunction machine (trade name: a modified iR-ADVC5560 machine; made by Canon Inc.) modified so as to enable adjustment of the power of the laser for image exposure.

First, in each of the electrophotographic photosensitive member, the initial film thickness of the surface layer was measured using an interference film thickness meter (trade name: MCPD-3700, made by Otsuka Electronics Co., Ltd.).

Next, the electrophotographic apparatus and the electrophotographic photosensitive members were left to stand in an environment at a temperature of 23° C. and a relative humidity of 50% for 24 hours, and the electrophotographic photosensitive members each were mounted on the cyan cartridge of the electrophotographic apparatus. First, the condition of the charging apparatus was initially set such that the surface of the electrophotographic photosensitive member was −700 V. The image exposure laser power was adjusted, and the setting of the quantity of light to reduce the potential from −700 V to −200 V was recorded therein.

Next, a halftone image was continuously output onto 50000 sheets of normal paper of a size A4 with a single color of cyan. The power of the laser for image exposure was set such that the density of the output halftone image measured by a spectrodensitometer (trade name: X-rite504, made by X-rite, Inc.) was 0.85. After the output of the halftone image, the electrophotographic photosensitive member was removed from the electrophotographic apparatus, and the film thickness of the surface layer was measured to calculate the difference between the initial film thickness of the surface layer and the film thickness thereof after the output of 50000 sheets, namely, the wear amount. The results of evaluation are shown in Table 1.

In Examples using the hole transporting compounds according to the present disclosure, the image deletion, the potential variation under a low temperature and low humidity environment, and the wear resistance were improved with a good balance.

TABLE 1

| | | | | | Results of evaluation of electrophotographic photosensitive member | | | | |
|---|---|---|---|---|---|---|---|---|---|
| | Exemplary | Amount | Exemplary | Amount | | | Evaluation of | Potential | |
| | compound | (parts) of | compound | (parts) of | | | image deletion | variation under | |
| | No. | compound | No. | compound | | | under high | low temperature | |
| | represented | represented | represented | represented | | Residual | temperature and | and low humidity | Wear |
| | by Formula | by Formula | by Formula | by Formula | Sensitivity | potential | high humidity | environment | amount |
| | (1) | (1) | (2) | (2) | [μJ/cm²] | [−V] | environment [rank] | [V] | [μm] |
| Example 1 | 1-4 | 6 | 2-1 | 4 | 0.25 | 44 | 4 | 6 | 0.7 |
| Example 2 | 1-4 | 6 | 2-4 | 4 | 0.25 | 42 | 5 | 5 | 0.8 |
| Example 3 | 1-5 | 6 | 2-1 | 4 | 0.25 | 40 | 4 | 5 | 1.0 |
| Example 4 | 1-10 | 6 | 2-1 | 4 | 0.26 | 40 | 4 | 6 | 0.6 |
| Example 5 | 1-10 | 6 | 2-3 | 4 | 0.25 | 38 | 5 | 6 | 0.7 |
| Example 6 | 1-16 | 6 | 2-1 | 4 | 0.25 | 47 | 4 | 8 | 0.9 |
| Example 7 | 1-17 | 6 | 2-1 | 4 | 0.25 | 53 | 4 | 11 | 1.1 |
| Example 8 | 1-20 | 6 | 2-7 | 4 | 0.25 | 39 | 6 | 6 | 0.8 |
| Example 9 | 1-22 | 6 | 2-1 | 4 | 0.25 | 41 | 5 | 7 | 0.7 |
| Example 10 | 1-28 | 6 | 2-1 | 4 | 0.26 | 45 | 5 | 8 | 0.9 |
| Example 11 | 1-32 | 6 | 2-4 | 4 | 0.26 | 36 | 6 | 6 | 0.8 |
| Example 12 | 1-31 | 8 | 2-1 | 2 | 0.25 | 31 | 5 | 4 | 2.1 |
| Example 13 | 1-31 | 7 | 2-1 | 3 | 0.25 | 33 | 5 | 5 | 1.4 |
| Example 14 | 1-31 | 6 | 2-1 | 4 | 0.26 | 41 | 5 | 7 | 0.8 |
| Example 15 | 1-31 | 5 | 2-1 | 5 | 0.27 | 54 | 4 | 12 | 0.6 |
| Example 16 | 1-31 | 4 | 2-1 | 6 | 0.29 | 82 | 4 | 17 | 0.2 |
| Example 17 | 1-34 | 6 | 2-1 | 4 | 0.26 | 46 | 5 | 8 | 0.9 |
| Example 18 | 1-46 | 6 | 2-1 | 4 | 0.26 | 49 | 5 | 10 | 0.8 |
| Example 19 | 1-52 | 6 | 2-1 | 4 | 0.27 | 55 | 6 | 11 | 1.0 |
| Example 20 | 1-55 | 6 | 2-1 | 4 | 0.29 | 61 | 6 | 15 | 1.1 |
| Example 21 | 1-34 | 6 | 2-1 | 4 | 0.28 | 63 | 5 | 22 | 0.8 |
| Comparative | 1-10 | 6 | Comparative | 4 | 0.29 | 72 | 1 | 25 | 0.8 |
| Example 1 | | | compound | | | | | | |
| | | | No. 1 | | | | | | |
| Comparative | 1-10 | 6 | Comparative | 4 | 0.28 | 75 | 1 | 31 | 1.4 |
| Example 2 | | | compound | | | | | | |
| | | | No. 2 | | | | | | |
| Comparative | 1-10 | 6 | Comparative | 4 | 0.28 | 70 | 2 | 20 | 2.6 |
| Example 3 | | | compound | | | | | | |
| | | | No. 3 | | | | | | |
| Comparative | Comparative | 6 | 2-1 | 4 | 0.28 | 69 | 3 | 24 | 0.9 |
| Example 4 | compound | | | | | | | | |
| | No. 4 | | | | | | | | |
| Comparative | Comparative | 5 | Comparative | 5 | 0.27 | 70 | 1 | 32 | 0.9 |
| Example 5 | compound | | compound | | | | | | |
| | No. 5 | | No. 6 | | | | | | |

Use of the polymerizable compound represented by Formula (2) results in photosensitive members having high image deletion properties under a high temperature and high humidity environment and high wear resistance, and further having an improved potential variation under a low temperature and low humidity environment.

From the results shown in Table 1, the electrophotographic photosensitive members according to the present disclosure had high electrical properties and durability properties. Furthermore, for the image deletion, the photosensitive members according to Examples also have performance more significantly excellent than that of the photosensitive members according to Comparative Examples.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-018940, filed Feb. 5, 2019, which is hereby incorporated by reference herein in its entirety.

What is claimed is:

1. An electrophotographic photosensitive member comprising:
a support; and
a photosensitive layer on the support,
a surface layer of the electrophotographic photosensitive member containing a copolymerization product of a composition including a hole transporting compound represented by Formula (1) and a compound represented by Formula (2): 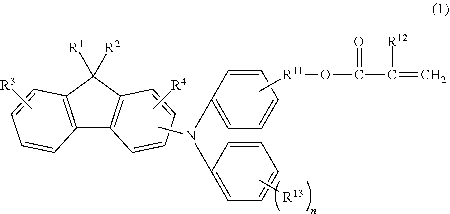
(where R¹ and R² each independently represent an alkyl group having 1 or more and 8 or less carbon atoms;
R³ and R⁴ each independently represent a hydrogen atom or an alkyl group having 1 or more and 4 or less carbon atoms;
R¹¹ represents an alkylene group having 2 or more and 6 or less carbon atoms;
R¹³ represents a hydrogen atom, an alkyl group having 1 or more and 4 or less carbon atoms, an alkoxy group having 1 or more and 4 or less carbon atoms, a phenyl group, or a benzyl group;
n represents 1 to 5;
R¹² represents a hydrogen atom or a methyl group); 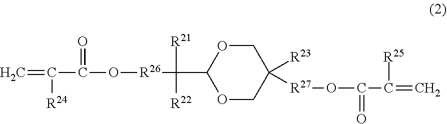
(where R²¹ and R²² each independently represent an alkyl group having 1 or more and 4 or less carbon atoms, or a substituted or unsubstituted aryl group; the substituent included in the aryl group is an alkyl group having 1 or more and 4 or less carbon atoms;
R²¹ and R²² may be bonded to each other to form a ring;
R²³ represents an alkyl group having 1 or more and 4 or less carbon atoms;
R²⁴ and R²⁵ each independently represent a hydrogen atom or a methyl group;
R²⁶ and R²⁷ each independently represent an alkylene group having 1 or more and 4 or less carbon atoms).

2. The electrophotographic photosensitive member according to claim 1, wherein the mass of the hole transporting compound represented by Formula (1) contained in the composition is 1.0 times or more and 3.0 times or less the mass of the compound represented by Formula (2) contained in the composition.

3. The electrophotographic photosensitive member according to claim 1, wherein R¹ and R² in Formula (1) each independently are an alkyl group having 1 or more and 6 or less carbon atoms.

4. The electrophotographic photosensitive member according to claim 3, wherein R¹ and R² in Formula (1) are an alkyl group having 2 or more and 4 or less carbon atoms.

5. The electrophotographic photosensitive member according to claim 1, wherein R¹¹ in Formula (1) is an alkylene group having 2 or 3 carbon atoms.

6. The electrophotographic photosensitive member according to claim 1, wherein at least one of R²¹ and R²² in Formula (2) is an alkyl group having 2 or more carbon atoms.

7. The electrophotographic photosensitive member according to claim 1, wherein the photosensitive layer is a laminate of a charge-generating layer, a hole transporting layer, and the surface layer sequentially disposed on the support, and the hole transporting layer contains at least one hole transporting compound selected from the group consisting of a hole transporting compound represented by Formula (3) and a hole transporting compound represented by Formula (4): 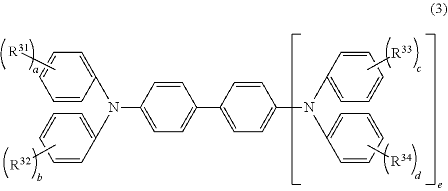
(where R³¹ to R³⁴ each independently represent a hydrogen atom or an alkyl group having 1 or more and 4 or less carbon atoms; a, b, c, and d represent 0 to 5; e represents 0 or 1); 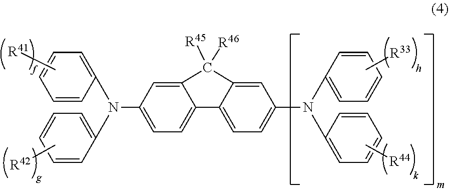
(where R⁴¹ to R⁴⁴ each independently represent a hydrogen atom or an alkyl group having 1 or more and 4 or less carbon atoms; R⁴⁵ and R⁴⁶ each independently represent an alkyl group having 1 or more and 8 or less carbon atoms; f, g, h, and k represent 0 to 5; m represents 0 or 1).

8. An electrophotographic apparatus comprising an electrophotographic photosensitive member, a charging member, an exposure member, a developing member, and a transfer member,
wherein the electrophotographic photosensitive member comprises a support and a photosensitive layer on the support,
a surface layer of the electrophotographic photosensitive member containing a copolymerization product of a composition including a hole transporting compound represented by Formula (1) and a compound represented by Formula (2): 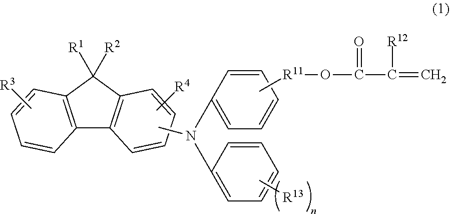
(where R¹ and R² each independently represent an alkyl group having 1 or more and 8 or less carbon atoms;
R³ and R⁴ each independently represent a hydrogen atom or an alkyl group having 4 or less carbon atoms;
R¹¹ represents an alkylene group having 2 or more and 6 or less carbon atoms;
R¹³ represents a hydrogen atom, an alkyl group having 1 or more and 4 or less carbon atoms, an alkoxy group having 1 or more and 4 or less carbon atoms, a phenyl group, or a benzyl group;
n represents 1 to 5;
R¹² represents a hydrogen atom or a methyl group); 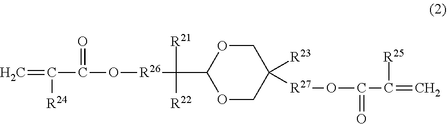
(where R²¹ and R²² each independently represent an alkyl group having 1 or more and 4 or less carbon atoms, or a substituted or unsubstituted aryl group; the substituent included in the aryl group is an alkyl group having 4 or less carbon atoms; R²¹ and R²² may be bonded to each other to form a ring;
R²³ represents an alkyl group having 1 or more and 4 or less carbon atoms;
R²⁴ and R²⁵ each independently represent a hydrogen atom or a methyl group;
R²⁶ and R²⁷ each independently represent an alkylene group having 1 or more and 4 or less carbon atoms).

9. A process cartridge detachable from the body of the electrophotographic apparatus, the process cartridge comprising:
an electrophotographic photosensitive member; and
at least one selected from the group consisting of a charging member, a developing member, a transfer member, and a cleaning member,
wherein the electrophotographic photosensitive member comprises a support and a photosensitive layer on the support, a surface layer of the electrophotographic photosensitive member containing a copolymerization product of a composition including a hole transporting compound represented by Formula (1) and a compound represented by Formula (2): 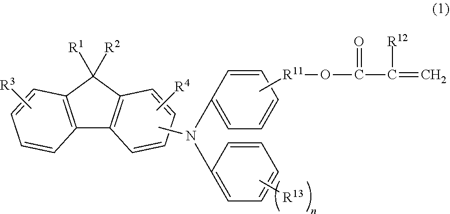
(where R¹ and R² each independently represent an alkyl group having 1 or more and 8 or less carbon atoms;
R³ and R⁴ each independently represent a hydrogen atom or an alkyl group having 1 or more and 4 or less carbon atoms;
R¹¹ represents an alkylene group having 2 or more and 6 or less carbon atoms;
R¹³ represents a hydrogen atom, an alkyl group having 1 or more and 4 or less carbon atoms, an alkoxy group having 4 or less carbon atoms, a phenyl group, or a benzyl group;
n represents 1 to 5;
R¹² represents a hydrogen atom or a methyl group); 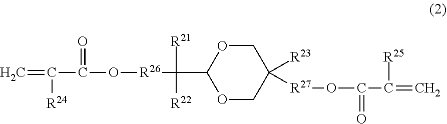
(where R²¹ and R²² each independently represent an alkyl group having 1 or more and 4 or less carbon atoms, or a substituted or unsubstituted aryl group; the substituent included in the aryl group is an alkyl group having 1 or more and 4 or less carbon atoms;
R²¹ and R²² may be bonded to form a ring;
R²³ represents an alkyl group having 1 or more and 4 or less carbon atoms;
R²⁴ and R²⁵ each independently represent a hydrogen atom or a methyl group;
R²⁶ and R²⁷ each independently represent an alkylene group having 1 or more and 4 or less carbon atoms).

10. A method of manufacturing an electrophotographic photosensitive member comprising a support and a photosensitive layer on the support, the method comprising:
forming a coating of a coating solution for a surface layer having a composition comprising a hole transporting compound represented by Formula (1) and a compound represented by Formula (2); and curing the coating to form a surface layer of the electrophotographic photosensitive member: 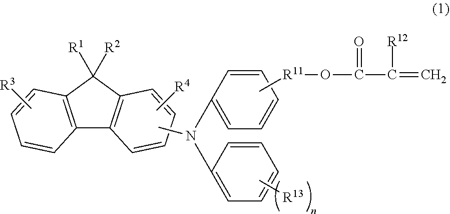
(where R¹ and R² each independently represent an alkyl group having 1 or more and 8 or less carbon atoms;
R³ and R⁴ each independently represent a hydrogen atom or an alkyl group having 1 or more and 4 or less carbon atoms;
R¹¹ represents an alkylene group having 2 or more and 6 or less carbon atoms;
R¹³ represents a hydrogen atom, an alkyl group having 1 or more and 4 or less carbon atoms, an alkoxy group having 4 or less carbon atoms, a phenyl group, or a benzyl group;
n represents 1 to 5;
R¹² represents a hydrogen atom or a methyl group); 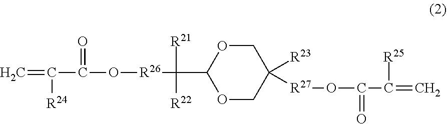
(where R²¹ and R²² each independently represent an alkyl group having 1 or more and 4 or less carbon atoms, or a substituted or unsubstituted aryl group; the substituent included in the aryl group is an alkyl group having 1 or more and 4 or less carbon atoms;
R²¹ and R²² may be bonded to each other to form a ring;
R²³ represents an alkyl group having 1 or more and 4 or less carbon atoms;
R²⁴ and R²⁵ each independently represent a hydrogen atom or a methyl group;
R²⁶ and R²⁷ each independently represent an alkylene group having 1 or more and 4 or less carbon atoms).

11. The method of manufacturing an electrophotographic photosensitive member according to claim 10, wherein the mass of the hole transporting compound represented by Formula (1) in the coating solution for a surface layer is 1.0 times or more and 3.0 times or less the mass of the compound represented by Formula (2) contained in the composition.
